(19) United States
(12) Patent Application Publication
(10) Pub. No.: US 2022/0026708 A1
(43) Pub. Date: Jan. 27, 2022

(54) IMAGE DISPLAY DEVICE AND ELECTRONIC APPARATUS

(71) Applicant: SONY GROUP CORPORATION, TOKYO (JP)

(72) Inventor: SHINGO OHKAWA, TOKYO (JP)

(21) Appl. No.: 17/296,540

(22) PCT Filed: Oct. 18, 2019
(86) PCT No.: PCT/JP2019/041088

§ 371 Date: May 24, 2021

(51) Int. Cl. G02B 26/08

(52) U.S. Cl. CPC G02B 26/0891; G02F 1/133526

(57) ABSTRACT

An image display device of the present disclosure includes: a first optical unit configured to change a traveling direction of an optical path by refracting light from a display element; a second optical unit to which the light refracted by the first optical unit enters; and a control unit configured to set a timing to change the traveling direction of the optical path to a state that is different among a plurality of regions, which are determined by dividing a display region of the display element in a scanning direction by controlling a distance between the first optical unit and the second optical unit so as to correspond to each of the plurality of regions.

### TECHNICAL FIELD

The present disclosure relates to an image display device and an electronic apparatus.

### BACKGROUND ART

In a projection type display device, which is an example of an image display device, a pixel shift method is used, that is, a method of artificially improving resolution of an image on a display panel (display element) having low resolution, by shifting a projection position of each pixel by time division and displaying this image. The pixel shift is performed by refracting light in an optical path shift device which is disposed on the optical path from the display panel to a projection lens (see Patent Literature 1, for example).

Patent Literature 1 discloses a technique to implement the pixel shift by disposing a plate prism between a spatial optical modulation element, which corresponds to a display panel (display element), and a projection lens, so as to be inclined from the normal plane of the optical axis, and performing parallel shift of the optical axis.

### CITATION LIST

### Patent Literature

[PTL1]

JP H11-298829A

### SUMMARY

### Technical Problem

According to the prior art disclosed in PTL1, in a case where the driving method of the display panel is a line-sequential driving, a region of which resolution drops due to the influence of the line-sequential driving is generated. Specifically, timing of the pixel shift deviates from the timing of the frame switching on the screen (that is, each frame is displayed at a position that considerably deviates from the original display position), therefore the image to be displayed becomes unclear.

In other words, according to the prior art disclosed in PTL1, the difference of shift timing within a screen caused by using the line-sequential driving type display panel is not considered, and the resolution cannot be improved throughout the screen because of the influence of the line-sequential driving.

It is an object of the present disclosure to provide an image display device which can improve resolution throughout the screen even if the display panel is the line-sequential driving type, and an electronic apparatus equipped with this image display device.

### Solution to Problem

To achieve the above object, an image display device of the present disclosure includes: a first optical unit configured to change a traveling direction of an optical path by refracting light from a display element; a second optical unit to which the light refracted by the first optical unit enters, and a control unit configured to set a timing to change the traveling direction of the optical path to a state that is different among a plurality of regions, which are determined by dividing a display region of the display element in a scanning direction, by controlling a distance between the first optical unit and the second optical unit so as to correspond to each of the plurality of regions.

Further, in order to achieve the above object, an electronic apparatus of the present disclosure includes the image display device having the above mentioned configuration.

### BRIEF DESCRIPTION OF DRAWINGS

FIG. 1 is a schematic diagram indicating a basic configuration of an optical system of a three-LCD projection type display device, which is an example of an image display device of the present disclosure.

FIG. 2A is a schematic diagram of an optical path shift device according to a prior art which uses a parallel plate, and FIG. 2B is a diagram indicating a relationship of a sub-frame A before tilting (broken line) and a sub-frame D after tilting (solid line).

FIG. 3A is a diagram indicating a state of change of a tilt angle according to the prior art using a parallel plate, and FIG. 3B is a diagram indicating a relationship of pixel rewriting on a line-sequential driving type liquid crystal panel, frame switching and the tilt angle.

FIG. 4A and FIG. 4B are diagrams indicating a relationship of an optical path shift change and frame switching at the center of the screen according to the prior art.

FIG. 5A is a diagram indicating a locus of the pixel center when a sub-frame A is displayed at the center of the screen according to the prior art, and FIG. 5B is a diagram indicating a locus of the pixel center when a sub-frame D is displayed at the center of the screen according to the prior art.

FIG. 6A indicates an image based on an original pixel signal (8K), FIG. 6B indicates an image (ideal state) in a case where a binary shift was completely performed in the display element at low resolution (4K), FIG. 6C indicates an image at the center of the screen in a case where a shift was performed on the display element at low resolution using a parallel plate, and FIG. 6D indicates an image in the upper portion/lower portion of the screen in a case where a shift was performed in the display element at low resolution using the parallel plate.

FIG. 7A and FIG. 7B are diagrams indicating a relationship of the optical path shift change and frame switching in the upper portion of the screen according to the prior art.

FIG. 8A is a diagram indicating a locus of the pixel center when the sub-frame A is displayed in the upper portion of the screen according to the prior art, and FIG. 8B is a diagram indicating a locus of the pixel center when the sub-frame D is displayed in the upper portion of the screen according to the prior art.

FIG. 9A and FIG. 9B are diagrams indicating a relationship of the optical path shift change and frame switching in the lower portion of the screen according to the prior art.

FIG. 10A is a diagram indicating a locus of the pixel center when the sub-frame A is displayed in the lower portion of the screen according to the prior art, and FIG. 10B is a diagram indicating a locus of the pixel center when the sub-frame D is displayed in the lower portion of the screen according to the prior art.

FIG. 11 is a schematic perspective view of the optical path shift device according to first embodiment.

FIG. 12 is a schematic side view of the optical path shift device according to the first embodiment.

FIG. 13 is a diagram for explaining a control to change a distance from a first optical unit to a second optical unit periodically among a plurality of regions.

FIG. 14A is a waveform diagram indicating a change of tilt angles (inclination angles) of the first optical unit and the second optical unit, and FIG. 14B is a waveform diagram indicating a pixel shift amount (pixel moving amount) after passing the first optical unit and the second optical unit.

FIG. 15 is a schematic diagram indicating a change of the pixel shift amount (pixel moving amount) at time t₁ to t₅.

FIG. 16A is a diagram indicating a state of change of the tilt angle in the optical path shift device according to the first embodiment, and FIG. 16B is a diagram indicating a relationship of pixel rewriting and frame switching.

FIG. 17A and FIG. 17B are diagrams indicating a relationship of the optical path shift change and frame switching in the center of the screen according to the first embodiment.

FIG. 18A is a diagram indicating a locus of the pixel center when the sub-frames A/D are displayed at the center of the screen according to the first embodiment, and FIG. 18B indicates an image at the center of the screen in the case where the optical path was shifted on the display element at low resolution (4K) by the optical path shift device according to the first embodiment.

FIG. 19A and FIG. 19B are diagrams indicating a relationship of the optical path shift change and frame switching in the upper portion of the screen according to the first embodiment.

FIG. 20A is a diagram indicating a locus of the pixel center when the sub-frames A/D are displayed in the upper portion of the screen according to the first embodiment, and FIG. 20B indicates an image of the upper portion of the screen in the case where the optical path was shifted on the display element at low resolution (4K) by the optical path shift device according to the first embodiment.

FIG. 21A and FIG. 21B are diagrams indicating a relationship of the optical path shift change and frame switching in the lower portion of the screen according to the first embodiment.

FIG. 22A is a diagram indicating a locus of the pixel center when the sub-frames A/D are displayed in the lower portion of the screen according to the first embodiment, and FIG. 22B indicates an image of the upper portion of the screen in the case where the optical path was shifted on the display element at low resolution (4K) by the optical path shift device according to the first embodiment.

FIG. 23A is a diagram indicating a state of a change of the tilt angle in the optical path shift device according to second embodiment, and FIG. 23B is a diagram indicating a relationship of pixel rewriting and frame switching.

FIG. 24A and FIG. 24B are diagrams indicating a relationship of the optical path shift change and frame switching in the center of the screen according to the second embodiment.

FIG. 25A is a diagram indicating a locus of the pixel center when the sub-frames A/D are displayed at the center of the screen according to the second embodiment, and FIG. 25B indicates an image at the center of the screen in the case where the optical path was shifted on the display element at low resolution (4K) by the optical path shift device according to the second embodiment.

FIG. 26A and FIG. 26B are diagrams indicating a relationship of the optical path shift change and frame switching in the upper portion of the screen according to the first embodiment.

FIG. 27A is a diagram indicating a locus of the pixel center when the sub-frames A/D are displayed in the upper portion of the screen according to the second embodiment, and FIG. 27B indicates an image of the upper portion of the screen in the case where the optical path was shifted on the display element at low resolution (4K) by the optical path shift device according to the second embodiment.

FIG. 28A and FIG. 28B are diagrams indicating a relationship of the optical path shift change and frame switching in the lower portion of the screen according to the second embodiment.

FIG. 29A is a diagram indicating a locus of the pixel center when the sub-frames A/D are displayed in the lower portion of the screen according to the second embodiment, and FIG. 29B indicates an image of the lower portion of the screen in the case where the optical path was shifted on the display element at low resolution (4K) by the optical path shift device according to the second embodiment.

FIG. 30 is a schematic perspective view of an optical path shift device according to third embodiment.

FIG. 31 is a diagram indicating a state of change of the tilt angle in the optical path shift device according to the third embodiment.

FIG. 32 is a schematic perspective view of an optical path shift device according to fourth embodiment.

FIG. 33 is a diagram indicating a state of change of the tilt angle in the optical path shift device according to the fourth embodiment.

FIG. 34A is a diagram indicating a state of change of the tilt angle in the optical path shift device according to fifth embodiment, and FIG. 34B is a diagram indicating a relationship of pixel rewriting and frame switching.

FIG. 35A and FIG. 35B are diagrams indicating a relationship of an optical path shift change and frame switching in the center of the screen according to the fifth embodiment.

FIG. 36 is a diagram indicating a locus of the pixel canter when the sub-frames A/B/D/C are displayed at the center of the screen according to the fifth embodiment.

FIG. 37A indicates an image based on an original image signal (8K), FIG. 37B indicates an image (ideal state) in a case where four-level shift was completely performed in the display element at low resolution (4K), and FIG. 37C indicates an image at the center of the screen in a case where a shift was performed on the display element at low resolution (4K) by the optical path shift device according to the fifth embodiment.

FIG. 38A and FIG. 38B are diagrams indicating a relationship of the optical path shift change and frame switching in the upper portion of the screen according to the fifth embodiment.

FIG. 39A is a diagram indicating a locus of the pixel center when the sub-frames A/B/D/C are displayed in the upper portion of the screen according to the fifth embodiment, and FIG. 39B indicates an image in the upper portion of the screen in a case where the optical path was shifted on the display element at low resolution (4K) by the optical path shift device according to the fifth embodiment.

FIG. 40A and FIG. 40B are diagrams indicating a relationship of the optical path shift change and frame switching in the lower portion of the screen according to the fifth embodiment.

FIG. 41A is a diagram indicating a locus of the pixel center when the sub-frames A/B/D/C are displayed in the lower portion of the screen according to the fifth embodiment, and FIG. 41B indicates an image in the lower portion of the screen in a case where the optical path was shifted on the display element at low resolution (4K) by the optical path shift device according to the fifth embodiment.

FIG. 42 indicates an original 8K assumed image, images in a case where frame switching is a two-position shift of ADADAD . . . , and images in a case where frame switching is a four-position shift of ABDCABDC . . . .

FIG. 43A is a front view of a lens interchangeable mirrorless single lens type digital still camera according to Application first embodiment, and FIG. 43B is a rear view of the digital still camera.

FIG. 44 is an external view of a head mounted display according to Application the second embodiment.

FIG. 45 is a schematic diagram of a head up display according to Application the third embodiment.

### DESCRIPTION OF EMBODIMENTS

Embodiments of the technique of the present disclosure (hereafter referred to as “embodiment”) will now be described in detail with reference to the drawings. The technique of the present disclosure is not limited to the embodiment, and various numeric values and the like in the embodiment are examples. In the following description, same composing elements, or composing elements having a same function are denoted with a same reference sign, and redundant description thereof is omitted. The description will be performed according to the following sequence.

1. General description on image display device and electronic apparatus of present disclosure
2. Image display device to which technique of present disclosure is applied
2-1. Configuration example of projection type display device
2-2. Pixel shift
3. Embodiment of present disclosure
3-1. First embodiment (example where both first and second optical units are constituted of an edge plate-shaped member)
3-2. Second embodiment (modification of first embodiment: example where frame switching and frequency of tilt change are changed)
3-3. Third embodiment (example where third optical unit is added to first and second optical units)
3-4. Fourth embodiment (modification of first embodiment: example where first and second optical units are tilted along axis 45° inclined from display element)
3-5. Fifth embodiment (modification of first embodiment: example where frame switching is performed at four positions)

### 4. Modifications

5. Application examples of technique of present disclosure
5-1. Application Example 1 (example of digital still camera)
5-2. Application Example 2 (example of head mounted display)
5-3. Application Example 3 (example of head up display)
6. Possible configuration of present disclosure

<General Description on Image Display Device and Electronic Apparatus of Present Disclosure>

The image display device and an electronic apparatus of the present disclosure may be configured such that the first optical unit is constituted of at least one wedge plate-shaped member, of which cross-section, parallel with the optical axis, is wedge-shaped, and the second optical unit is constituted of a plate member.

In the image display device and the electronic apparatus of the present disclosure, including the above mentioned preferred configuration, the control unit may be configured to set the timing to change the traveling direction of the optical path to a state that is different among a plurality of regions, by changing the inclination angles of the first optical unit and the second optical unit with respect to the optical axis. Further, the control unit may be configured to refract the light from the display element using the first optical unit, so as to periodically change the distance from the first optical unit to the second optical unit among the plurality of regions.

In the image display device and the electronic apparatus of the present disclosure, including the above mentioned preferred configuration, the second optical unit may be configured to be constituted of a wedge plate-shaped member, of which inclination is the same as the wedge plate-shaped member of the first optical unit. Further, the first optical unit and the second optical unit may be configured to have a total thickness thereof that is the same in a region corresponding to the optical path from the display element. In this case, the second optical unit has a function to return the traveling direction of a beam, of which traveling direction of the optical path was changed by the first optical unit, back to the original traveling direction of the beam.

The image display device and the electronic apparatus of the present disclosure, including the above mentioned preferred configuration, may be configured such that in the periodic change of the inclination angles of the first optical unit and the second optical unit with respect to the optical axis, the frequencies of the periodic change are the same, and the phases of the periodic change are different. In this case, the first optical unit and the second optical unit may be configured to be housed in a frame including a tilt axis along the X axis, so that the inclination angles are changeable around the X axis, which is along the normal line of a cross-section of the wedge of the wedge plate-shaped member, and the frame may be configured such that the inclination angle is changeable around the Y axis, which is along the normal line of a cross-section of the wedge-shaped member having a uniform thickness. Further, in the periodic change of the inclination angles of the first optical unit and the second optical unit with respect to the optical axis, the frequencies of the periodic change of the inclination angles are the same, and the phases of the period change of the inclination angles are different on the X axis, and the frequencies of the periodic change and phases of the period change of the inclination angles are the same on the Y axis.

The image display device and the electronic apparatus of the present disclosure, including the above mentioned preferred configuration, may be configured to further include a third optical unit to which the light passed through the second optical unit enters. In this case, the third optical unit may be configured to be constituted of a plate member that is inclinable around the Y axis, which is along a normal line of a cross-section of the wedge plate-shaped member having a uniform thickness. The frequency of the periodic change of the inclination angle of the third optical unit on the Y axis may be the same as the periodic change of the inclination angles of the first optical unit and the second optical unit.

The image display device and the electronic apparatus of the present disclosure, including the above mentioned preferred configuration, may be configured such that the driving method of the display element is a line-sequential driving method. In this case, the direction of changing the timing, to change the traveling direction of the optical path, among the plurality of regions may be the same as the scanning direction of the line-sequential driving method.

The image display device and the electronic apparatus of the present disclosure, including the above mentioned preferred configuration, may be configured such that a direction of the Y axis, which is along the normal line of the cross-section of the wedge plate-shaped member having a uniform thickness, is the same as the scanning direction of the line-sequential driving method. Further, the frequencies of the periodic change of the inclination angles of the first optical unit and the second optical unit with respect to the optical axis may be frequencies that are not higher than a pixel rewriting frequency in the display unit.

<Image Display Device to which Technique of Present Disclosure is Applied>

Initially an image display to which the technique of the present disclosure is applied, that is, the image display device of the present disclosure, will be described. Here a three-LCD projection type display device (that is, a projector) will be described as an example of the image display device of the present disclosure.

[Configuration Example of Projection Type Display Device]

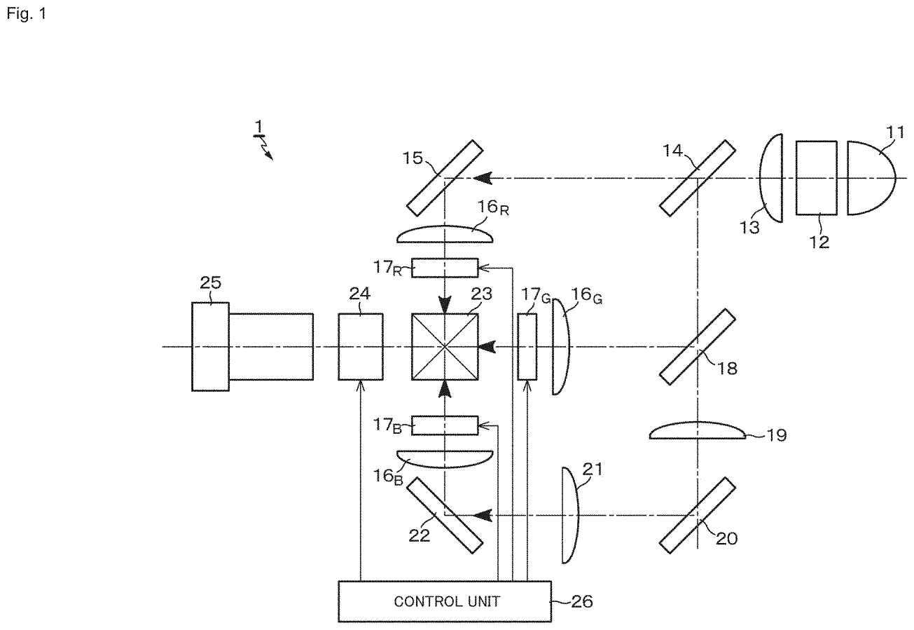

The three-LCD projection type display device performs color display by additive color mixing. Using a liquid crystal panel (display element) as a light modulation unit (light valve) for each of the three primary colors of the light (red (R), green (G) and blue (B)), an image of each primary color is formed on each of the three liquid crystal panels respectively, after which the images are combined by a prism. FIG. 1 indicates an overview of a basic configuration of an optical system of the three-LCD projection type display device.

A three-LCD projection type display device 1 according to this example includes a light source 11 (e.g. white lamp). The white light emitted from the light source 11 is converted from P-polarized light into S-polarized light by a polarization conversion element 12, is homogenized by a fly-eye lens 13, and enters a dichroic mirror 14. Then only a specific color component, such as a component of R (red) light, transmits through the dichroic mirror 14, and the rest of the color components are reflected by the dichroic mirror 14. The light component of R that transmitted through the dichroic mirror 14 changes the optical path using a mirror 15, and enters a liquid crystal panel 17R of R through a lens 16R.

A light component reflected by a dichroic mirror 14, such as a light component of G (green), is reflected by a dichroic mirror 18, and at the same time, a light component of B (blue) transmits through this dichroic mirror 18. The light component of G reflected by the dichroic mirror 18 enters a liquid crystal panel 17G of G through a lens 16G. The light component B that transmitted through the dichroic mirror 18 passes through a lens 19, changes the optical path thereof using a mirror 20, then passes through a lens 21, changes the optical path thereof using a mirror 22, and enters a liquid crystal panel 17B of B through a lens 16B.

Although illustration is omitted in FIG. 1, a polarizing plate is disposed on the incidence side and the emitting side of each liquid crystal panel 17R, 17G and 17B respectively. As is well known, a normally white mode can be set by disposing a pair of polarizing plates on the incidence side and the emitting side, such that the respective polarizing directions are vertical to each other (crossed Nicol state), and a normally black mode can be set by disposing the pair of polarizing plates such that the respective polarizing directions are parallel with each other (parallel Nicol state).

The light components R, G and B which passed through the respective liquid crystal panels 17R, 17G and 17B enter a cross prism 23, and are combined in this cross prism 23. The light combined in the cross prism 23 enters a projection lens 25 via an optical path shift device 24, and is projected onto a screen (not illustrated) by this projection lens 24.

The display methods used for the liquid crystal panels 17R, 17G and 17B are roughly classified into a transmission type and a reflection type. For the silicon materials of thin film transistors (TFT) used for pixels, amorphous silicon (amorphous semiconductor) and polysilicon (polycrystal semiconductor) are frequently used in the case of the transmission type liquid crystal panels. In the case of the reflection type liquid crystal panels, on the other hand, monocrystal silicon is frequently used. In the following, a simple case where the liquid crystal panels 17R, 17G and 17B are the transmission type liquid crystal panels will be described, but the liquid crystal panels 17R, 17G and 17B are not limited to the transmission type liquid crystal panels, but may be such liquid crystals as the reflection type and DLP® type.

In the projection type display device 1 having the above configuration, the display control of the liquid crystal panels 17R, 17G and 17B and the pixel shift control of the optical path shift device 24 are performed by a control unit 26, which is in charge of control of the entire system of the projection type display device 1. In the projection type display device 1 according to this example, it is assumed that the line-sequential driving method is used for the driving method of the liquid crystal panels 17R, 17G and 17B. Here “line-sequential driving method” refers to a driving method in which digital video signal, that are serial-inputted, are serial-parallel converted and latched, then are digital-analog converted and applied to the corresponding signal lines all at once as the signal voltage, for example.

[Pixel Shift]

The optical path shift device 24 is disposed on an optical path from the liquid crystal panels 17R, 17G and 17B to the projection lens 25, and executes the pixel shift by refracting the light combined by the cross prism 23. According to the pixel shift by the optical path shift device 24, the images on the display panels 17R, 17G and 17B having low resolution are disposed with shifting the projection positions of the pixels based on time-division, thereby the resolution of the image can be artificially improved.

In the following, the liquid crystal panels 17R, 17G and 17B may be collectively referred to as “liquid crystal panel 17”.

### PRIOR ART

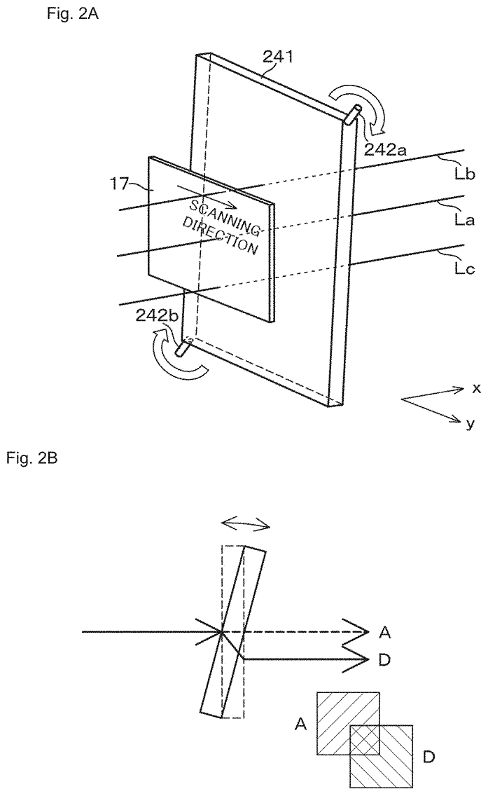

A prior art of the optical path shift device 24 using a parallel plate will be described here as a prior art. As illustrated in FIG. 2A, in the case of the prior art using a parallel plate 241, the pixel shift is executed by tilting (oscillating) a parallel plate 241 using tilt axes 242a and 242b which are 45° inclined from the liquid crystal panel 17 (a display element) so as to refract light. In FIG. 2A, a line La at the center is a line passing through the center of the screen (screen center), a line Lb on the upper side is a line passing through an upper portion of the screen, and a line Lc on the lower side is a line passing through a lower portion of the screen. The x direction is the direction of the optical axis, and the y direction is a direction vertical to the x direction. FIG. 2B indicates the relationship of a first sub-frame image A before tilting (broken line), and a second sub-frame image D after tilting (solid line).

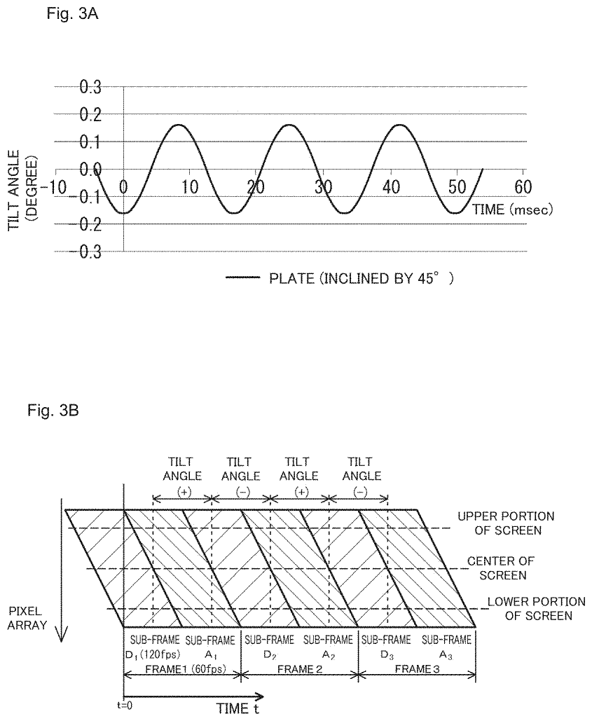

FIG. 3A indicates a state of change of the tilt angle according to the prior art using the parallel plate 241, and FIG. 3B indicates a relationship of pixel rewriting on the line-sequential driving type liquid crystal panel 17, frame switching and the tilt angle. Here a case of 60 Hz sine wave driving is indicated as an example. In the case of the liquid crystal panel 17 which uses the line-sequential driving method as the driving method, a region where resolution drops due to the influence of the line-sequential driving is generated.

The relationship of the optical path shift change and frame switching in the prior art will be described for each case of (1) center of the screen, (2) upper portion of the screen, and (3) lower portion of the screen respectively.

(1) In the Case of Center of the Screen

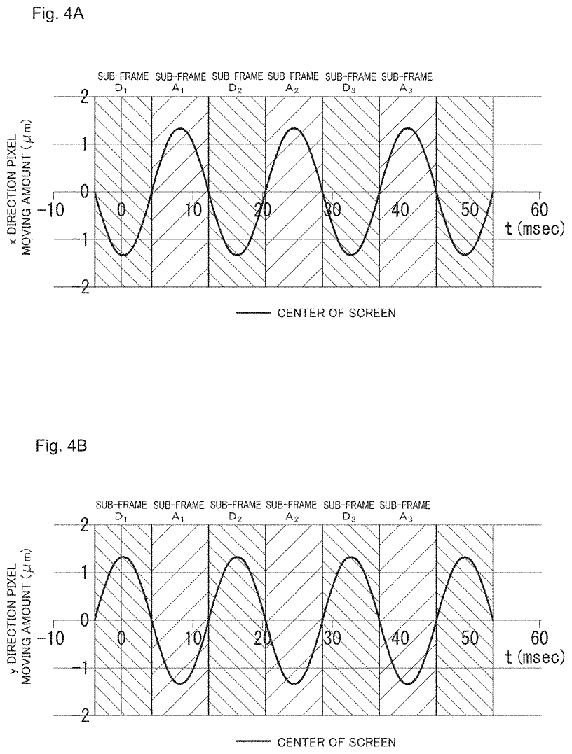

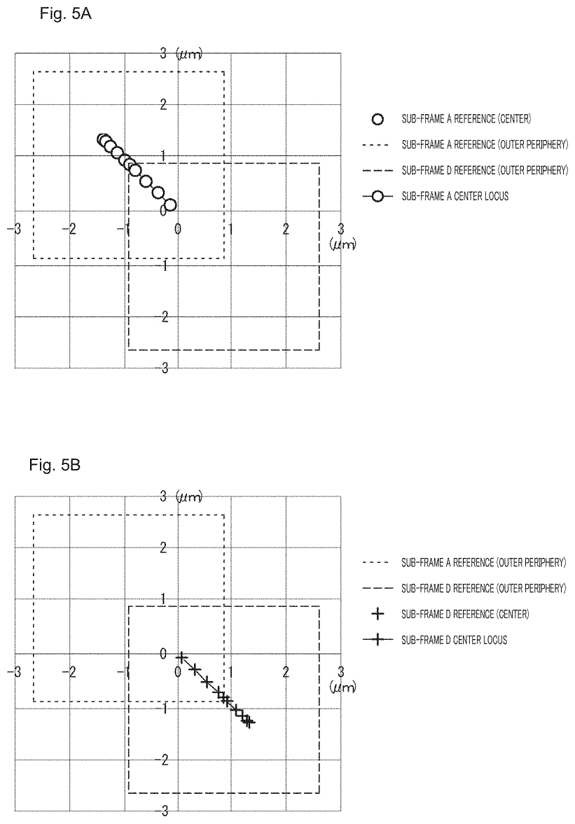

FIG. 4A and FIG. 4B indicate a relationship of the optical path shift change and frame switching at the center of the screen. FIG. 4A indicates the x direction pixel moving amount (μm), and FIG. 4B indicates the y direction pixel moving amount (μm). FIG. 5A indicates a locus of the pixel center when the sub-frame A is displayed at the center of the screen, and FIG. 5B indicates a locus of the pixel center when the sub-frame D is displayed at the center of the screen.

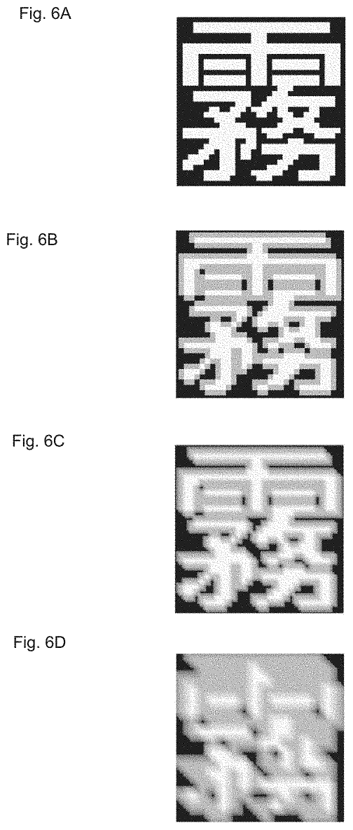

FIG. 6A indicates an image based on an original pixel signal (8K), FIG. 6B indicates an image (ideal state) in a case where a binary shift was completely performed in a display element (liquid crystal panel 17) at low resolution (4K), and FIG. 6C indicates an image at the center of the screen in a case where a shift was performed on the display element at low resolution (4K) using a parallel plate 241.

As the comparison of the image in FIG. 6B and the image in FIG. 6C clearly indicates, the timings of the shift with respect to the frame switching match at the center of the screen, and each frame is displayed in a position close to the original display position, therefore no significant problems occur in the displayed image.

(2) In the Case of Upper Portion of the Screen

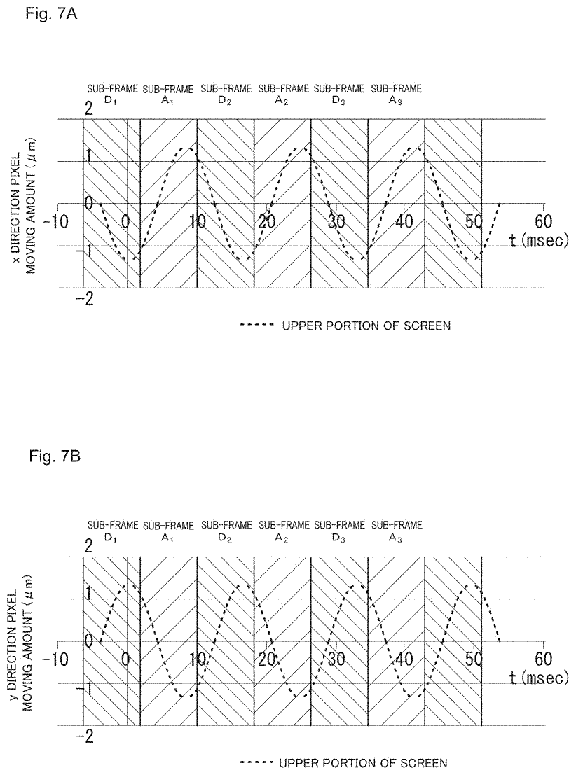

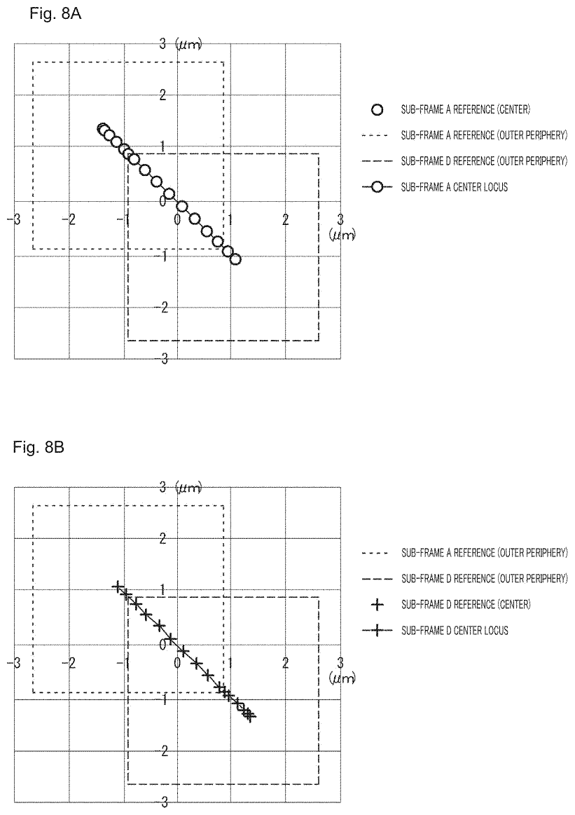

FIG. 7A and FIG. 7B indicate a relationship of the optical path shift change and frame switching in the upper portion of the screen. FIG. 7A indicates the x direction pixel moving amount (μm), and FIG. 7B indicates the y direction pixel moving amount (μm). FIG. 8A indicates a locus of the pixel center when the sub-frame A is displayed in the upper portion of the screen, and FIG. 8B indicates a locus of the pixel center when the sub-frame D is displayed in the upper portion of the screen.

FIG. 6D indicates an image in the upper portion of the screen in a case where a shift was performed in the display element at low resolution (4K) using a parallel plate. As the comparison of the image in FIG. 6B and the image in FIG. 6D clearly indicates, the timing of the shift with respect to the frame switching deviates in the upper portion of the screen, and each frame is displayed in a position significantly deviated from the original display position, therefore the displayed image also becomes unclear.

(3) In the Case of Lower Portion of the Screen

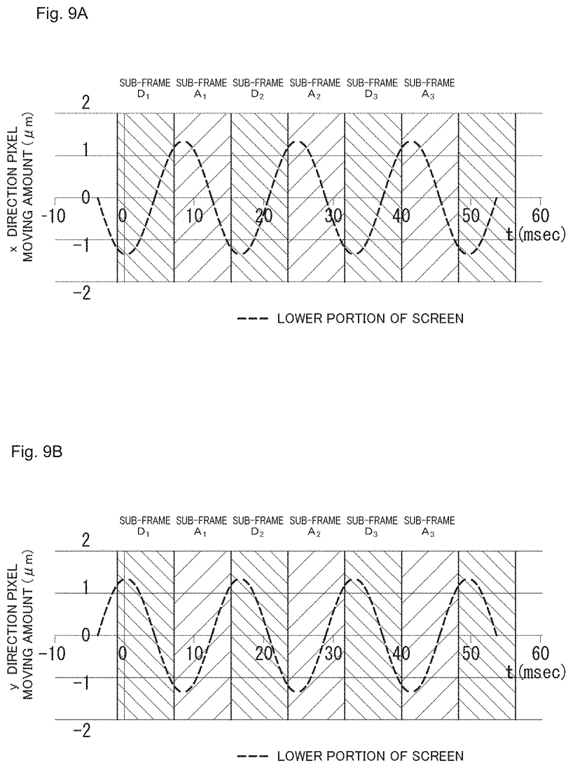

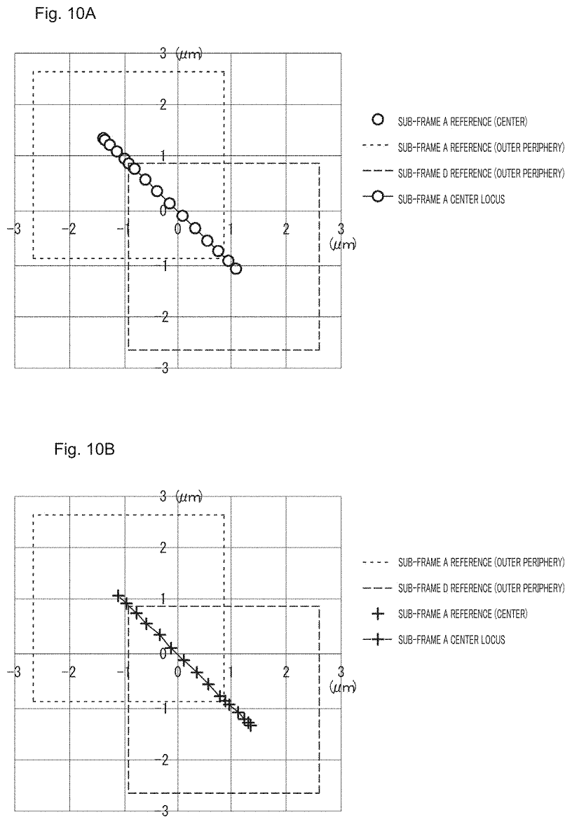

FIG. 9A and FIG. 9B indicate a relationship of the optical path shift change and frame switching in the lower portion of the screen. FIG. 9A indicates the x direction pixel moving amount (μm), and FIG. 9B indicates the y direction pixel moving amount (μm). FIG. 10A indicates a locus of the pixel center when the sub-frame A is displayed in the lower portion of the screen, and FIG. 10B indicates a locus of the pixel center when the sub-frame D is displayed in the lower portion of the screen.

An image in the lower portion of the screen in a case where a shift was performed in the display element at low resolution (4K) using the parallel plate 241 is also basically the same as the image in the upper portion of the screen indicated in FIG. 6D. In other words, the timing of the shift with respect to frame switching deviates in the lower portion of the screen, just like the upper portion of the screen, and each frame is displayed in a position significantly deviated from the original display position, therefore the displayed image also becomes unclear.

As mentioned above, according to the prior art using the parallel plate 241, in the case of the liquid crystal panel 17 using the line-sequential driving method as the driving method, images of other sub-frames coexist in the upper portion of the screen and the lower portion of the screen when a ¼ pitch shift is performed, hence resolution drops and the displayed image becomes clear.

### EMBODIMENT OF THE PRESENT DISCLOSURE

An object of the embodiment of the present disclosure is to improve resolution throughout the screen using the pixel shift method, even if the driving method of the display element (display panel) is the line-sequential driving method. To achieve this object, in this embodiment, an optical path shift device, which is disposed on the optical path from the display element and changes the traveling direction of the optical path, includes: a first optical unit that changes the traveling direction of the optical path by refracting the light from the display element; and a second optical unit to which the light refracted by the first optical unit enters.

Then a timing of the optical path shift, to change the traveling direction of the optical path, is set to a state that is different among a plurality of regions, which are determined by dividing a display region of the display element in a scanning direction, by controlling the distance between the first optical unit and the second optical unit, so as to correspond to each of the plurality of regions. Thereby the timing of the pixel shift within the screen can be adjusted so that cross-talk of a first sub-frame image and a second sub-frame image is not generated, and as a result, resolution can be improved throughout the screen.

Specific examples of the present embodiment, to improve the resolution throughout the screen using the pixel shift method, will be described below.

### First Embodiment

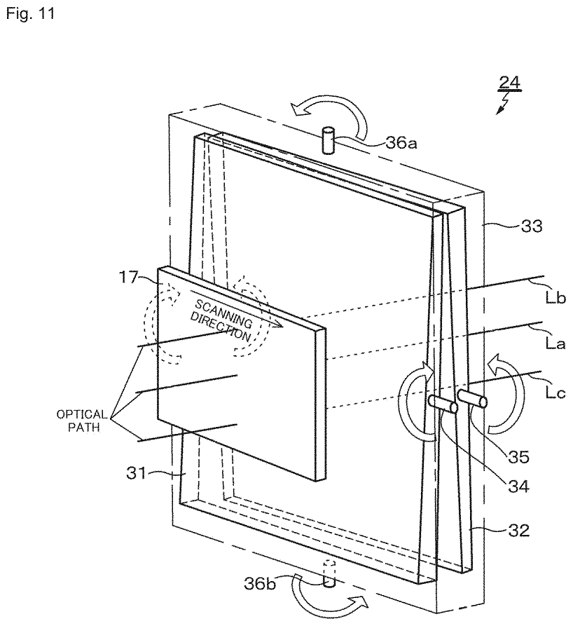

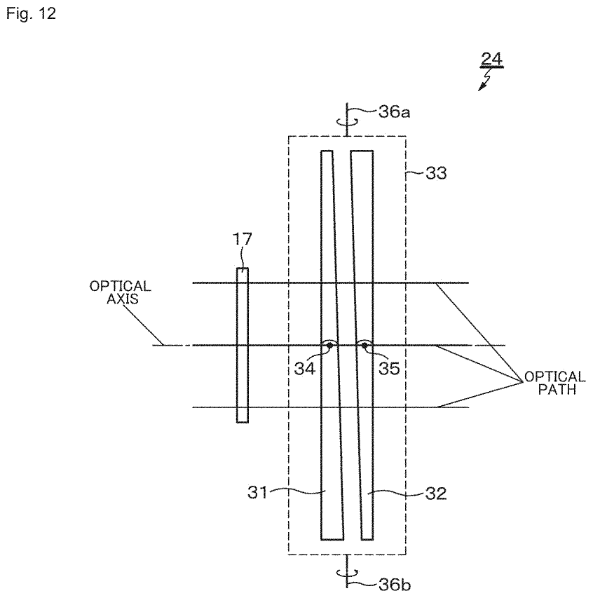

First embodiment is an example where both the first and second optical units are constituted of a wedge plate-shaped member of which cross-section, parallel with the optical axis, is wedge-shaped. FIG. 11 is a schematic perspective view of the optical path shift device according to the first embodiment, and FIG. 12 is a schematic side view of the optical path shift device according to the first embodiment.

The optical path shift device 24 according to the first embodiment includes a first optical unit 31 and as second optical unit 32. The first optical unit 31 is disposed between a liquid crystal panel 17, which is a display element, and the second optical unit 32, and changes a traveling direction of the optical path by refracting the light from the liquid crystal panel 17. The light refracted by the first optical unit 31 enters the second optical unit 32.

The first optical unit 31 is constituted of at least one wedge plate-shaped member, of which cross-section, parallel with the optical axis, is wedge-shaped. The second optical unit 32 is constituted of a wedge plate-shaped member of which inclination is the same as the wedge plate-shaped member of the first optical unit 31, for example, and is disposed to be vertically inverted from the first optical unit 31. The first optical unit 31 and the second optical unit 32 have about 2 to 1 mm thickness, for example. Although the wedge plate-shaped member is used for the second optical unit 32 in this embodiment, the member is not limited to a wedge plate-shaped member, and therefore any plate member may be used.

The first optical unit 31 and the second optical unit 32 are configured to be oscillatable (tiltable) around the X axis using the tilt axes 34 and 35 disposed on the side wall based on driving by an actuator (not illustrated). The first optical unit 31 and the second optical unit 32, including the tilt axes 34 and 35 along the X axis, are housed in a rectangular frame 33. The frame 33 housing the first optical unit 31 and the second optical unit 32 is configured to be oscillatable (tiltable) around the Y axis, using the tilt axes 36a and 36b disposed on the upper and lower walls, based on driving by an actuator (not illustrated).

Here the X axis, which is the center axis of oscillation of the first optical unit 31 and the second optical unit 32, is an axis along the normal line of the cross-section of the wedges of the first optical unit 31 and the second optical unit 32. The Y axis, which is the center axis of oscillation of the frame 33, is an axis along the normal line of the cross-section of the first optical unit 31 and the second optical unit 32 having a uniform thickness. The direction of the Y axis (oscillation direction) is the same as the scanning direction of the line-sequential driving method.

The driving control by the actuator for the tilt axes 34 and 35 of the first optical unit 31 and the second optical unit 32, and the driving control by the actuator for the tilt axes 36a and 36b of the frame 33, specifically the control for the inclination angles (tilt angles) of the first optical unit 31 and the second optical unit 32, are executed under control by the control unit 26 illustrated in FIG. 1. The control unit 26 sets the timing of the optical path shift (that is, the timing to change the traveling direction of the optical path) to a state that is different among a plurality of regions, which are determined by dividing a display region of the liquid crystal panel 17 in the scanning direction, by periodically changing the inclination angles of the first optical unit 31 and the second optical unit 32 with respect to the optical axis, so as to correspond to each of the plurality of regions.

Here a case where both the first optical unit 31 and the second optical unit 32 are constituted of wedge plate-shaped members is described, but the control of shifting the timing of the optical path shift can be performed even if the second optical unit 32 is not the wedge plate-shaped member, specifically, even if the second optical unit 32 is constituted of a plate member.

The control performed by the control unit 26, that is, the control to set the timing of the optical path shift to a state that is different among the plurality of regions by periodically changing the inclination angles of the first optical unit 31 and the second optical unit 32 with respect to the optical axis, will be described in concrete terms.

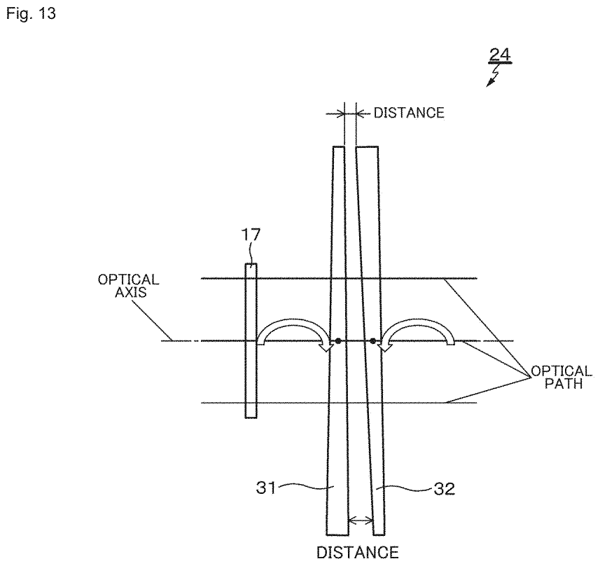

The control unit 26 refracts the light from the display element (that is, liquid crystal panel 17) using the first optical unit 31, which is constituted of at least one wedge plate-shaped member, and performs the control, as indicated in FIG. 13, so that the distance from the first optical unit 31 to the second optical unit 32 periodically changes differently among a plurality of regions (e.g. upper portion of screen/center of screen/lower portion of screen). By this control performed by the control unit 26, the timing of the optical path shift in a direction parallel with the optical axis can be set to a state that is different among the plurality of regions.

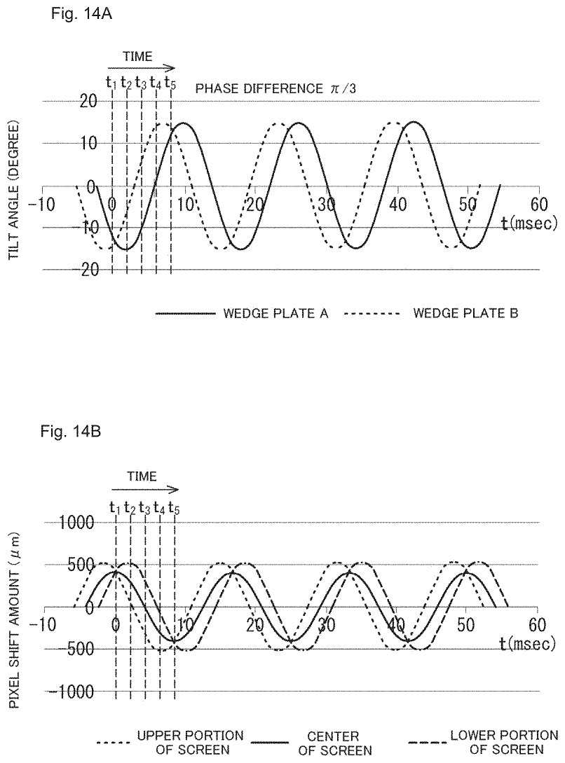

FIG. 14A is a waveform diagram indicating a change of the inclination angles (hereafter may be referred to as “tilt angles”) of the first optical unit 31 and the second optical unit 32, and FIG. 14B is a waveform diagram indicating a pixel shift amount (pixel moving amount) after passing the first optical unit 31 and the second optical unit 32. In FIG. 14A and FIG. 14B, the first optical unit 31 is indicated by “wedge plate A”, and the second optical unit 32 is indicated by “wedge plate B”. This is the same for the later mentioned diagrams related to the first optical unit 31 and the second optical unit 32.

As indicated in FIG. 14A, a control is performed in the periodic change of the tilt angles (inclination angles) of the first optical unit 31 and the second optical unit 32 with respect to the optical axis, so that the frequencies of the periodic change are the same and the phases of the periodic change are different. Here “frequencies are the same” includes not only a case where the frequencies are exactly the same, but also a case where the frequencies are substantially the same, and different variations generated due to design or manufacturing are permissible.

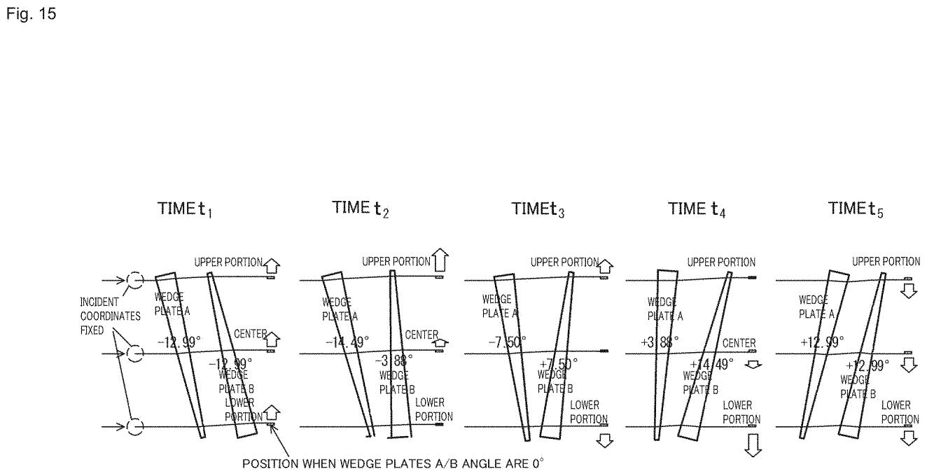

FIG. 15 is a schematic diagram indicating a change of the pixel shift amount (pixel moving amount) at time t₁ to t₅ in FIG. 14A and FIG. 14B. In FIG. 15, the length of the white arrow corresponds to the magnitude of the pixel shift amount. As the schematic diagram in FIG. 15 clearly indicates, the traveling direction of the beam which passed through the second optical unit 32 returns to the traveling direction of the beam (original beam) that entered the first optical unit 31 by the function of the second optical unit 32.

As described above, according to the optical path shift device 24 of the first embodiment, the distance from the first optical unit 31 to the second optical unit 32 is periodically changed to be different in the upper portion of the screen/center of the screen (screen center)/lower portion of the screen respectively, whereby the timing of the optical path shift to the direction parallel with the optical path can be set to a state that is different depending on the display region.

In the optical path shift device 24 according to the first embodiment, where both the first optical unit 31 and the second optical unit 32 are constituted of a wedge plate-shaped member, the total thickness of the first optical unit 31 and the second optical unit 32 is the same in a region corresponding to the optical path from the liquid crystal panel 17. Here “thickness is the same” includes not only the case where the thickness is exactly the same, but also a case where the thickness is substantially the same, and different variations generated due to design or manufacturing are permissible.

In the optical path shift device 24 according to the first embodiment having the above configuration, the first optical unit 31 has a function to change the traveling direction of the optical path by refracting the light from the liquid crystal panel 17. The second optical unit 32 has a function to return the traveling direction of a beam, of which optical path was shifted (optical path was changed) by the first optical unit 31, back to the original traveling direction of the beam (that is, the beam which entered the first optical unit 31) (see FIG. 15).

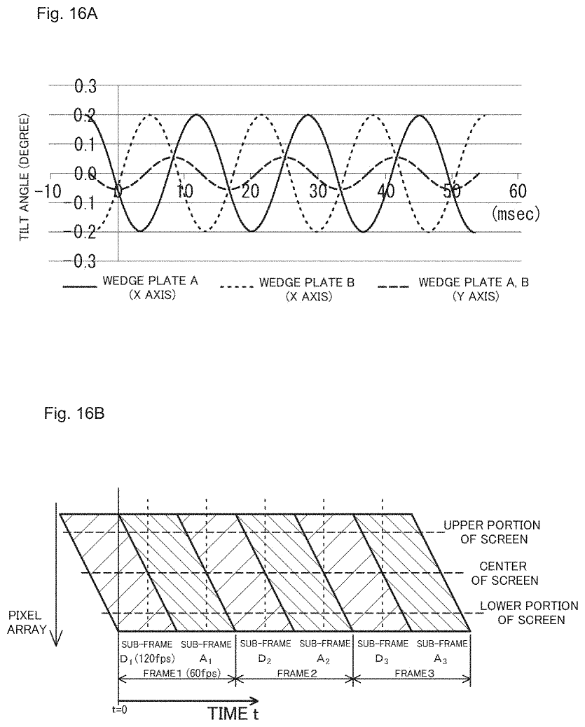

FIG. 16A indicates a state of change of the tilt angle in the optical path shift device 24 according to the first embodiment, and FIG. 16B indicates a relationship of pixel rewriting on the line-sequential driving type liquid crystal panel 17 and frame switching. Here for the first sub-frame image A and the second sub-frame image D, frames are switched by a two-position shift in the sequence of ADADAD . . . . This two-position shift frame switching can be implemented by known signal processing techniques. This is the same for the examples to be described later. Here a case of 60 Hz sine wave driving is indicated as an example.

Here in the periodic change of the inclination angles of the first optical unit 31 and the second optical unit 32, each of which is constituted of a wedge plate-shaped member, with respect to the optical axis, the frequencies of the periodic change of the inclination angle on the X axis, which is along the normal line of the cross-section of the wedge, are the same, and phases of the periodic change are different. Further, the frequencies of the periodic change of the inclination angle on the Y axis, which is along the normal line of the cross-section of the wedge plate-shaped member having a uniform thickness, are the same, and phases of the periodic change are also the same.

The direction to differentiate the timing of changing the traveling direction of the optical path among the plurality of regions, such as the upper portion of the screen/center of the screen/lower portion of the screen, is the same as the scanning direction of the line-sequential driving method, as indicated in FIG. 16B. The frequencies of the inclination angles of the first optical unit 31 and the second optical unit 32 with respect to the optical axis are frequencies that are not higher than the frequency of the pixel rewriting on the liquid crystal panel 17. This is the same for the examples described later.

The relationship of the optical path shift change and frame switching in the optical path shift device 24 according to the first embodiment will be described for each case of (1) center of the screen, (2) upper portion of the screen, and (3) lower portion of the screen respectively.

(1) In the Case of Center of the Screen

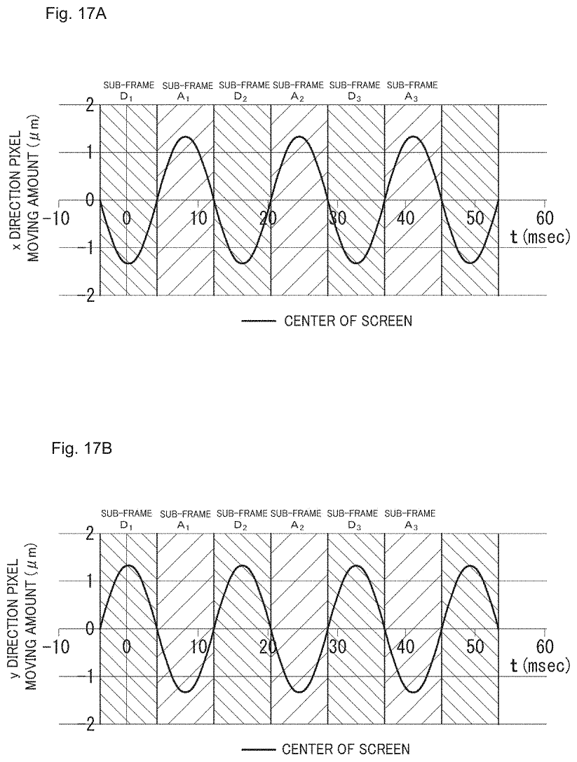

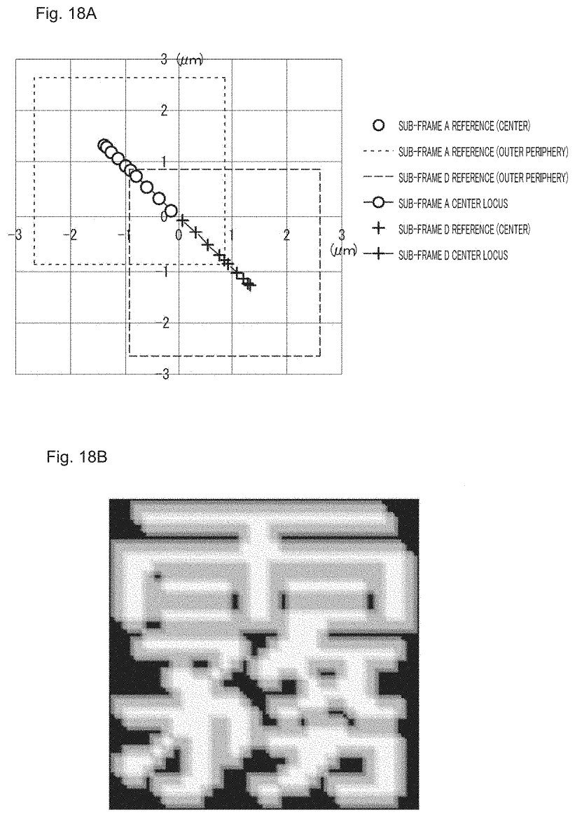

FIG. 17A and FIG. 17B indicate the relationship of the optical path shift change and frame switching at the center of the screen. FIG. 17A indicates the x direction pixel moving amount (μm), and FIG. 17B indicates the y direction pixel moving amount (μm). FIG. 18A indicates a locus of the pixel center when the sub-frames A/D are displayed at the center of the screen, and FIG. 18B indicates an image of the center of the screen in the case where the optical path was shifted on the display element at low resolution (4K) by the optical path shift device 24 according to the first embodiment.

In the optical path shift by the optical path shift device 24 according to the first embodiment, the timings of the shift with respect to frame switching match at the center of the screen, and each frame is displayed in a position close to the original display position, therefore no significant problem occurs in the displayed image, as indicated in FIG. 18B.

(2) In the Case of Upper Portion of the Screen

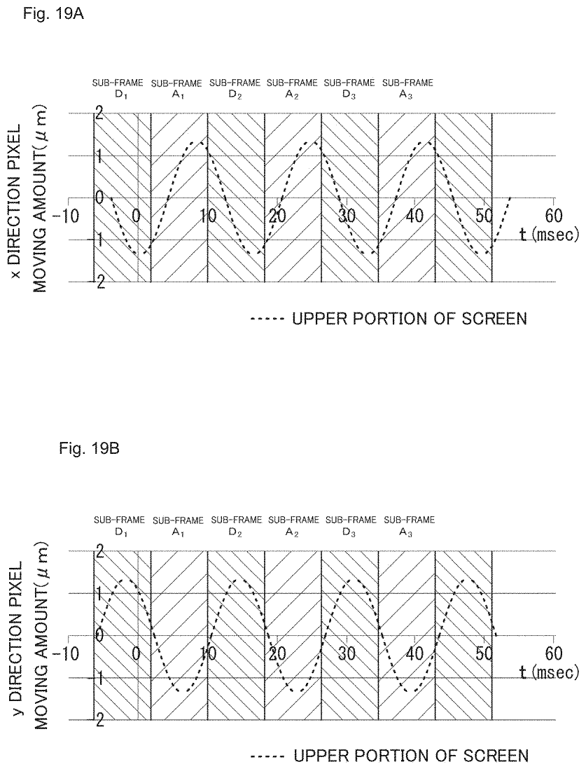

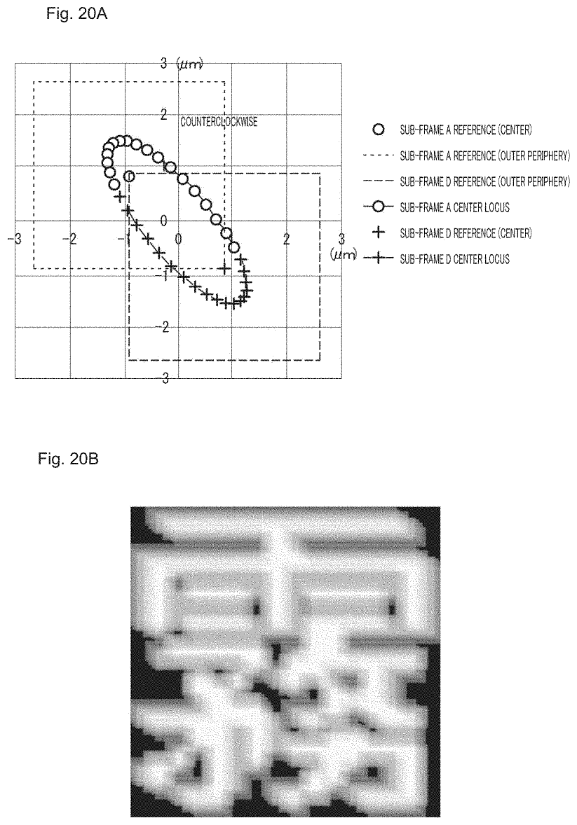

FIG. 19A and FIG. 19B indicate a relationship of the optical path shift change and frame switching in the upper portion of the screen. FIG. 19A indicates the x direction pixel moving amount (μm), and FIG. 19B indicates the y direction pixel moving amount (μm). FIG. 20A indicates a locus of the pixel center when the sub-frames A/D are displayed in the upper portion of the screen, and FIG. 20B indicates an image of the upper portion of the screen in the case where the optical path was shifted on the display element at low resolution (4K) by the optical path shift device 24 according to the first embodiment.

In the optical path shift by the optical path shift device 24 according to the first embodiment, deviation of the timing of the optical path shift on the screen with respect to frame switching is improved in the upper portion of the screen, and the degree of deviation of each frame from the original display position decreases, therefore the displayed image also improves, as indicated in FIG. 20B.

(3) In the Case of Lower Portion of the Screen

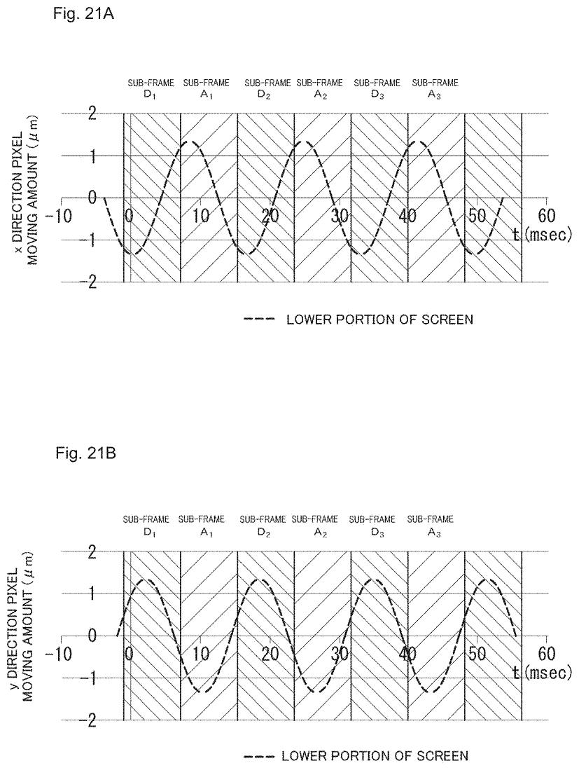

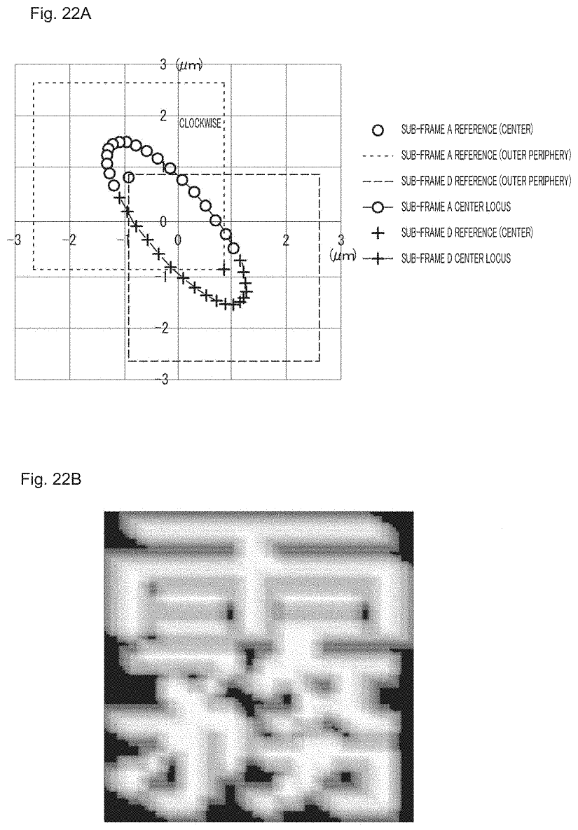

FIG. 21A and FIG. 21B indicate a relationship of the optical path shift change and frame switching in the lower portion of the screen. FIG. 21A indicates the x direction pixel moving amount (μm), and FIG. 21B indicates the y direction pixel moving amount (μm). FIG. 22A indicates a locus of the pixel center when the sub-frames A/D are displayed in the lower portion of the screen, and FIG. 22B indicates an image of the lower portion of the screen in the case where the optical path was shifted on the display element at low resolution (4K) by the optical path shift device 24 according to the first embodiment.

In the optical path shift by the optical path shift device 24 according to the first embodiment, deviation of the timing of the optical path shift with respect to frame switching is improved in the lower portion of the screen as well, just like in the upper portion of the screen, and the degree of deviation of each frame from the original display position decreases, therefore the displayed image also improves, as indicated in FIG. 22B.

### Second Embodiment

Second embodiment is a modification of the first embodiment, and is an example where frame switching and the frequency of tilt change are changed. The frames are switched in the sequence of ADADAD . . . in the first embodiment, but are switched in the sequence of ADDAADD . . . in the second embodiment. Further, the frequency of the tilt change (pixel shift) in the second embodiment is different from the first embodiment, and is ½ the case of the first embodiment, that is, frame frequency×½.

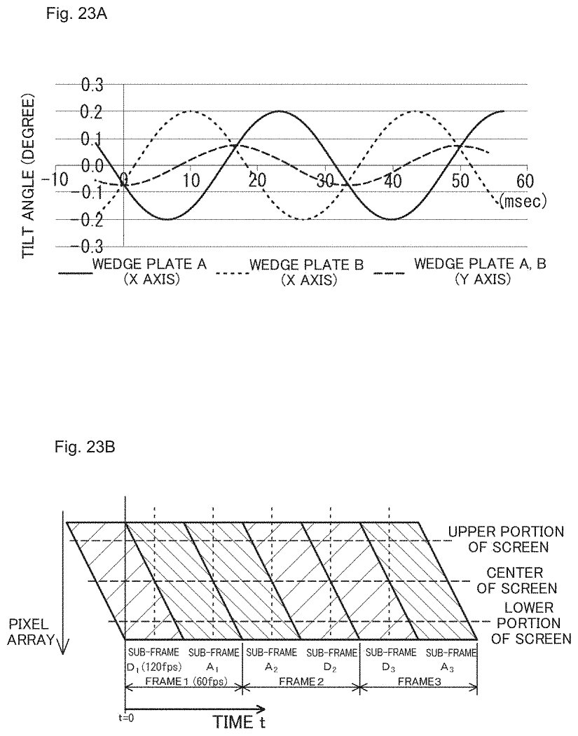

FIG. 23A indicates a state of change of the tilt angle in the optical path shift device 24 according to the second embodiment, and FIG. 23B indicates a relationship of pixel rewriting on the line-sequential driving type liquid crystal panel 17 and frame switching.

In the case of the second embodiment as well, in the periodic change of the inclination angles of the first optical unit 31 and the second optical unit 32, each of which is constituted of a wedge plate-shaped member, with respect to the optical axis, the frequencies of the periodic change of the inclination angle on the X axis, which is along the normal line of the cross-section of the wedge, are the same, and the phases of the periodic change are different. Further, the frequencies of the periodic change of the inclination angle on the Y axis, which is along the normal line of the cross-section of the wedge plate-shaped member having a uniform thickness, are the same, and phases of the periodic angle are also the same.

The relationship of the optical path shift change and frame shifting in the optical path shift device 24 according to the second embodiment will be described for each case of (1) center of the screen, (2) upper portion of the screen, and (3) lower portion of the screen respectively.

(1) In the Case of Center of the Screen

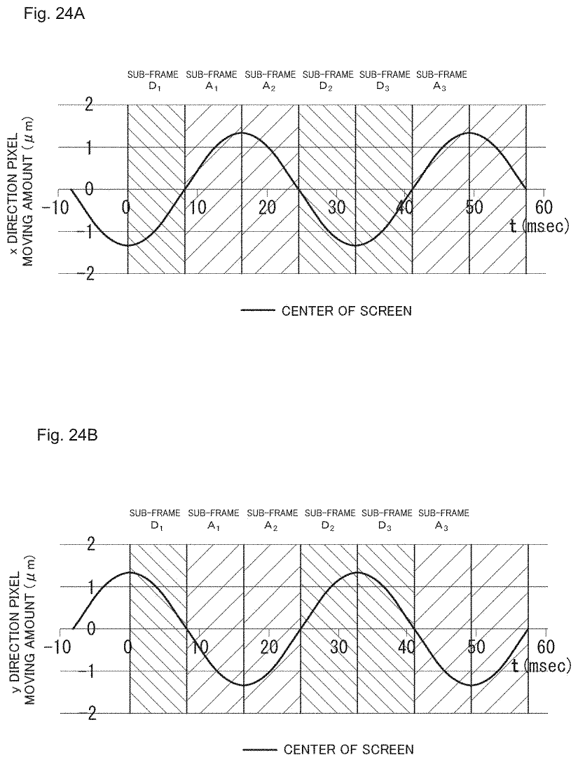

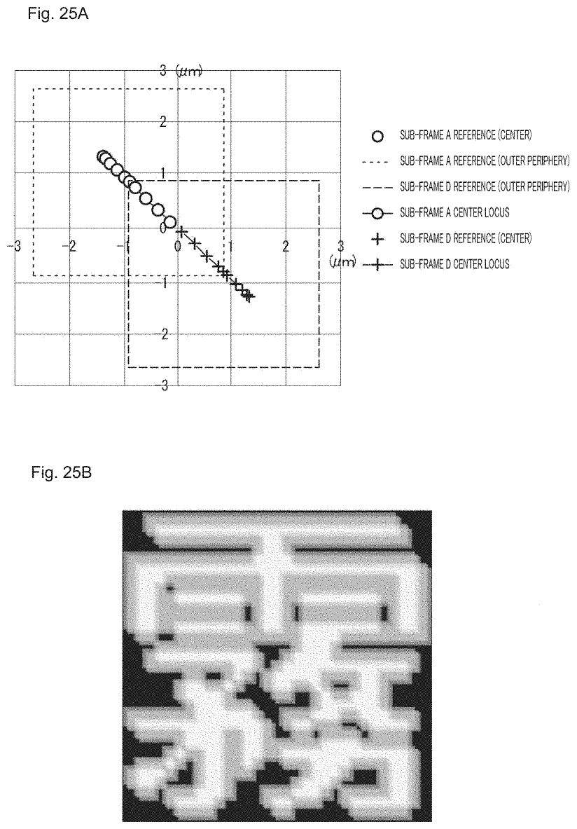

FIG. 24A and FIG. 24B indicate the relationship of the optical path shift change and frame switching at the center of the screen. FIG. 24A indicates the x direction pixel moving amount (μm), and FIG. 24B indicates the y direction pixel moving amount (μm). FIG. 25A indicates a locus of the pixel center when the sub-frames A/D are displayed at the center of the screen, and FIG. 25B indicates an image of the center of the screen in the case where the optical path was shifted on the display element at low resolution (4K) by the optical path shift device 24 according to the second embodiment.

In the optical path shift by the optical path shift device 24 according to the second embodiment, the timings of the shift with respect to frame switching match at the center of the screen, and each frame is displayed in a position close to the original display position, therefore no significant problems occur in the displayed image, as indicated in FIG. 25B.

(2) In the Case of Upper Portion of the Screen

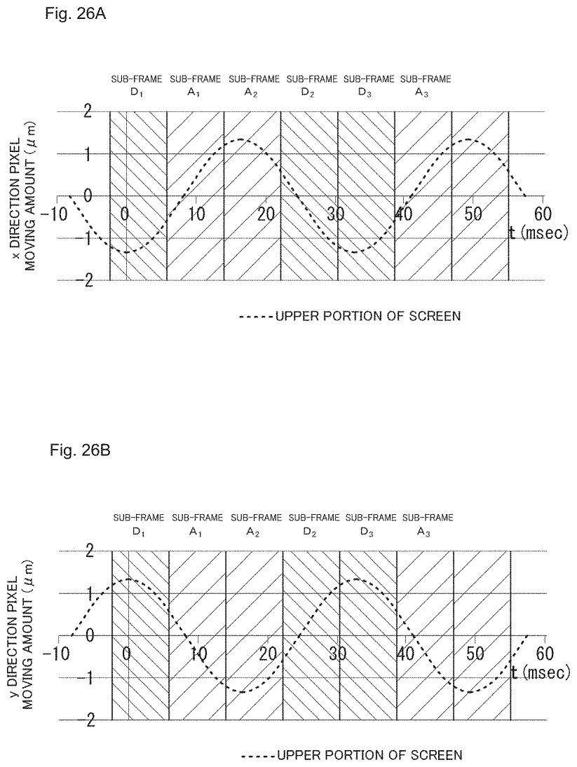

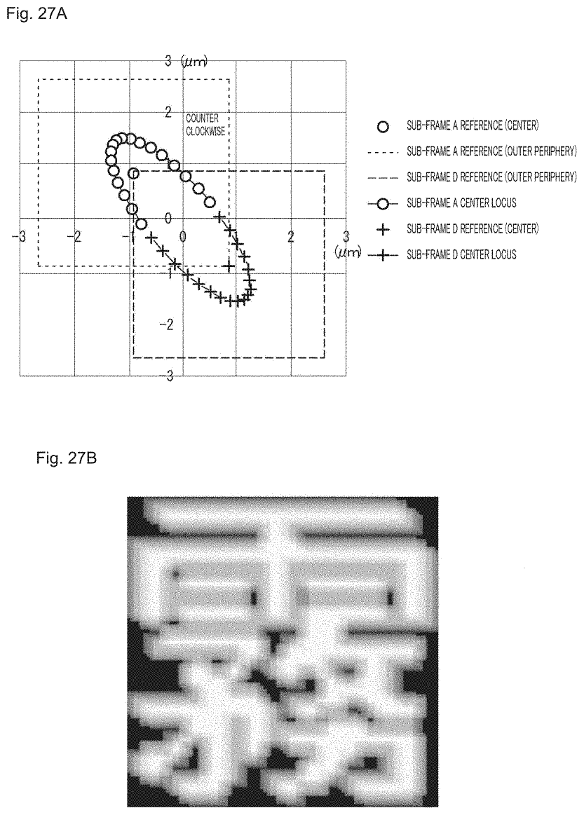

FIG. 26A and FIG. 26B indicate a relationship of the optical path shift change and frame switching in the upper portion of the screen. FIG. 26A indicates the x direction pixel moving amount (μm), and FIG. 26B indicates the y direction pixel moving amount (μm). FIG. 27A indicates a locus of the pixel center when the sub-frames A/D are displayed in the upper portion of the screen, and FIG. 27B indicates an image of the upper portion of the screen in the case where the optical path was shifted on the display element at low resolution (4K) by the optical path shift device 24 according to the second embodiment.

In the optical path shift by the optical path shift device 24 according to the second embodiment, deviation of the timing of the optical path shift on the screen with respect to frame shifting is improved in the upper portion of the screen, and the degree of deviation of each frame from the original display position decreases, therefore the displayed image also improves, as indicated in FIG. 27B.

(3) In the Case of Lower Portion of the Screen

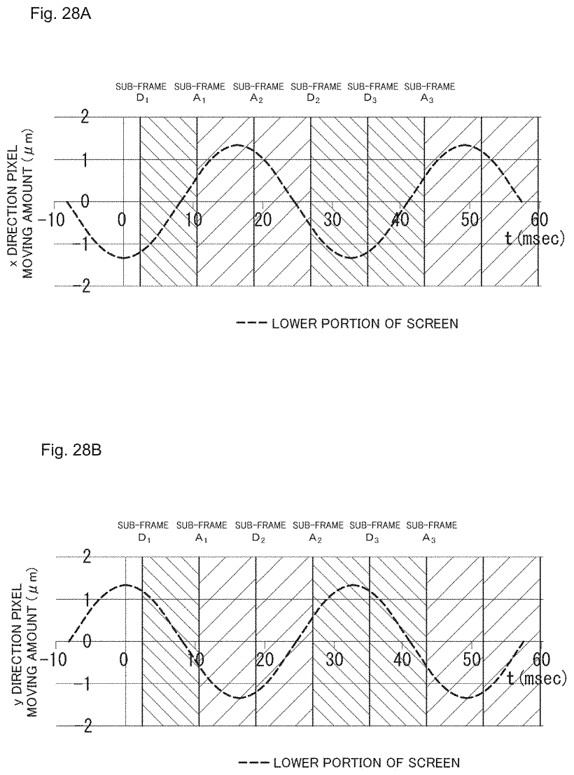

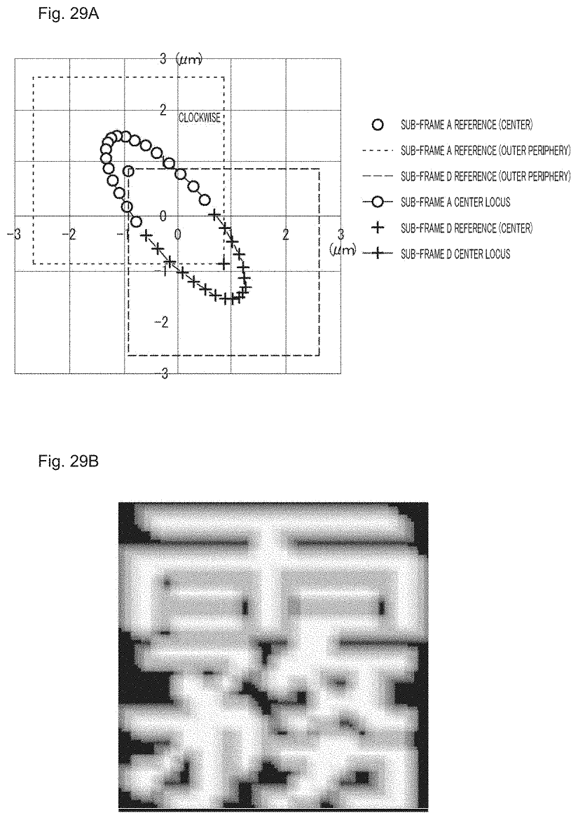

FIG. 28A and FIG. 28B indicate a relationship of the optical path shift change and frame switching in the lower portion of the screen. FIG. 28A indicates the x direction pixel moving amount (μm), and FIG. 28B indicates the y direction pixel moving amount (μm). FIG. 29A indicates a locus of the pixel center when the sub-frames A/D are displayed in the lower portion of the screen, and FIG. 29B indicates an image of the lower portion of the screen in the case where the optical path was shifted on the display element at low resolution (4K) by the optical path shift device 24 according to the second embodiment.

In the optical path shift by the optical path shift device 24 according to the second embodiment, deviation of the timing of the optical path shift with respect to frame switching is improved in the lower portion of the screen as well, just like in the upper portion of the screen, and the degree of deviation of each frame from the original display position decreases, therefore the displayed image also improves, as indicated in FIG. 29B.

### Third Embodiment

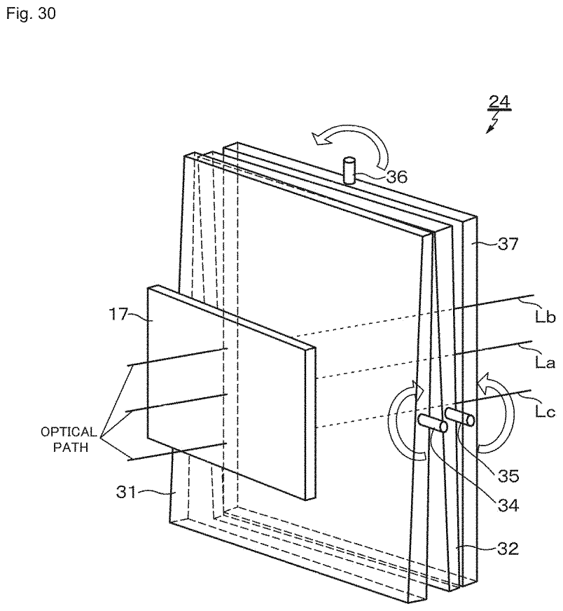

Third embodiment is an example where a third optical unit 37 is included in addition to the first optical unit 31 and the second optical unit 32. FIG. 30 is a schematic perspective view of an optical path shift device according to the third embodiment.

The optical path shift device 24 according to the third embodiment includes the third optical unit 37, in addition to the first optical unit 31 and the second optical unit 32. The first optical unit 31 and the second optical unit 32 are constituted of the wedge plate-shaped members, and are configured to be oscillatable (tiltable) around the X axis, using the tilt axes 34 and 35, just like the case of the first embodiment. The third optical unit 37 is constituted of a parallel plate, and is configured to be oscillatable (tiltable) around the Y axis using the tilt axis 36 along the Y axis.

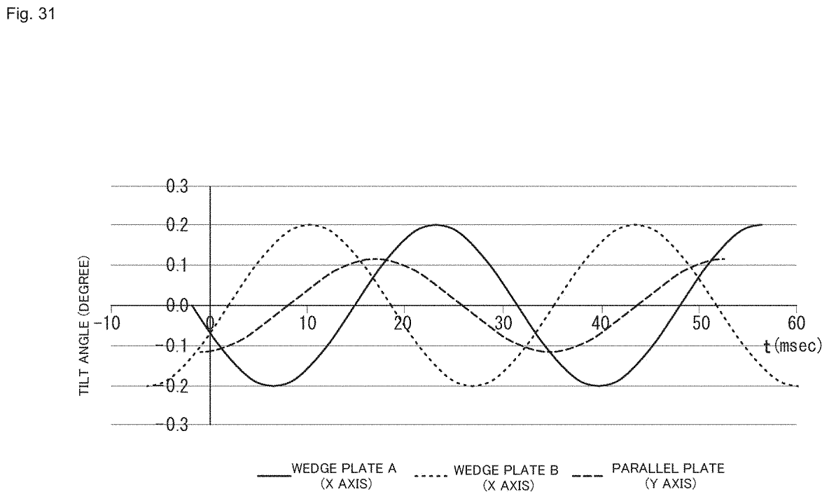

In the optical path shift device 24 according to the third embodiment, the frames are switched in the sequence of ADDAADD . . . , just like the case of the second embodiment. The frequency of the tilt change is also the same as the case of the second embodiment. Further, the frequency of the tilt change the frequency of the tilt change is also the same as the case of the second embodiment (e.g. about ½ the case of the first embodiment). FIG. 31 indicates a state of change of the tilt angle in the optical path shift device 24 according to the third embodiment.

As the comparison of FIG. 23A and FIG. 31 clearly indicates, in the case of the third embodiment, the amplitude of the Y axis in the change of the tilt angle is larger than the case of the second embodiment, since the optical path length is different from the case of the second embodiment. The functions and effects are the same as the case of the second embodiment. In other words, deviation of the timing of the optical path shift with respect to frame shifting is improved in the upper portion of the screen/lower portion of the screen, and the degree of deviation of each frame from the original display position further decreases, therefore the displayed image can be improved.

### Fourth Embodiment

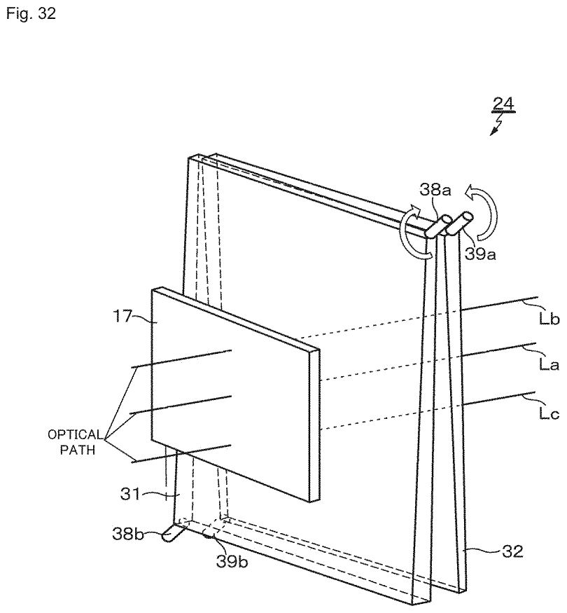

Fourth embodiment is a modification of the first embodiment, and is an example where the first optical unit 31 and the second optical unit 32 are tilted (oscillated) at an axis that is 45° inclined from the display element. FIG. 32 is a schematic perspective view of the optical path shift device according to the fourth embodiment.

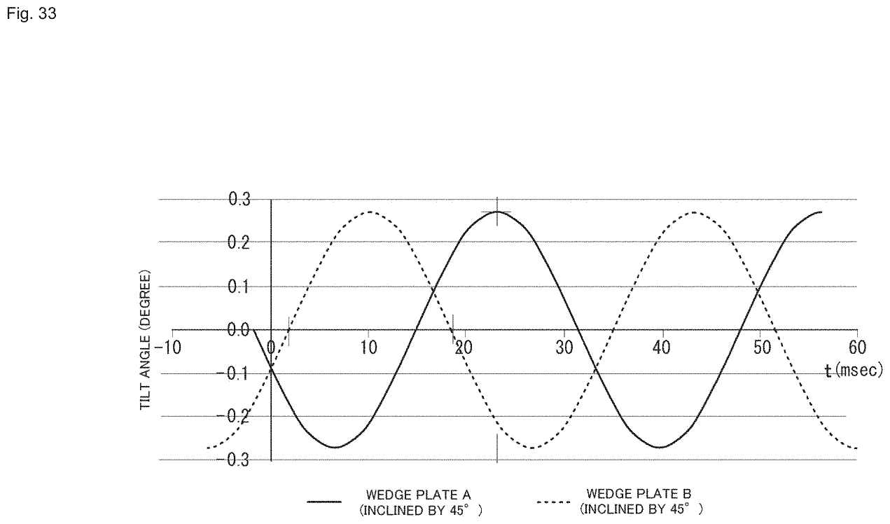

In the second embodiment and the third embodiment, three-axis oscillation (tilting) is used (two X axes and one Y axis), while in the fourth embodiment, two-axis oscillation (tilting) based on tilt axes 38a and 38b and tilt axes 39a and 39b, which are 45° inclined from the display element (liquid crystal panel 17), are used. FIG. 33 indicates a state of change of the tilt angle in the optical path shift device 24 according to the fourth embodiment.

In the case of the fourth embodiment, where two-axis oscillation based on the tilt axes that are 45° inclined from the display element is used as well, the functions and effects similar to the case of the three-axis oscillation in the second embodiment and the third embodiment can be acquired. In other words, deviation of the timing of the optical path shift with respect to frame shifting is improved in the upper portion of the screen/lower portion of the screen, and the degree of deviation of each frame from the original display portion further decreases, therefore the displayed image can be improved.

### Fifth Embodiment

Fifth embodiment is a modification of the first embodiment, and is an example where frames are switched at four positions. The configuration of the optical path shift device according to the fifth embodiment is basically the same as the optical path shift device according to the first embodiment, and is based on three-axis oscillation (two X axes and one Y axis). In the first embodiment, frames are switched at two positions (ADADAD . . . ), but in the fifth embodiment, frames are switched at four positions (ABDCABDC . . . ). This frame switching at four positions can be implemented by known signal processing techniques.

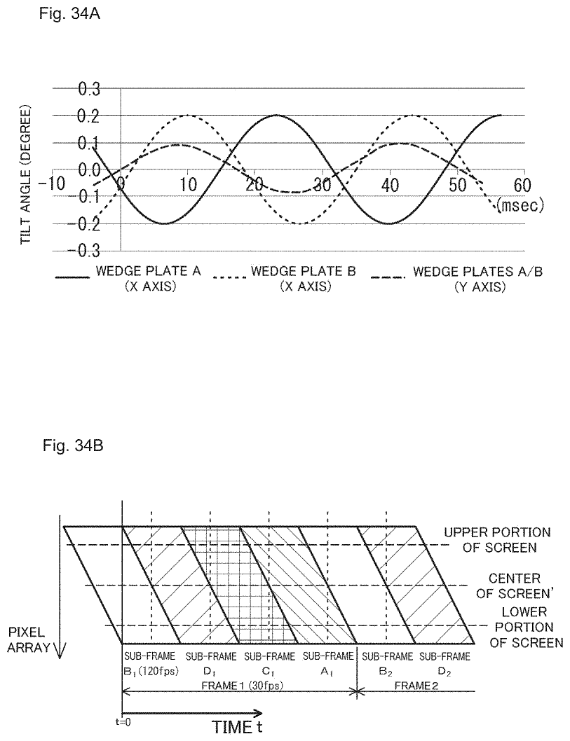

Further, in the periodic change of the tilt angles (inclination angles) of the first optical unit 31 and the second optical unit 32 with respect to the optical axis, the phase of the Y axis tilting is different from the case of the first embodiment. FIG. 34A indicates a state of change of a tilt angle in the optical path shift device 24 according to the fifth embodiment, and FIG. 34B indicates a relationship of pixel rewriting on the line-sequential driving type liquid crystal panel 17 and frame switching.

The relationship of the optical path shift change and frame switching in the optical path shift device 24 according to the fifth embodiment will be described for each case of (1) center of the screen, (2) upper portion of the screen, and (3) lower portion of the screen respectively.

(1) In the Case of Center of the Screen

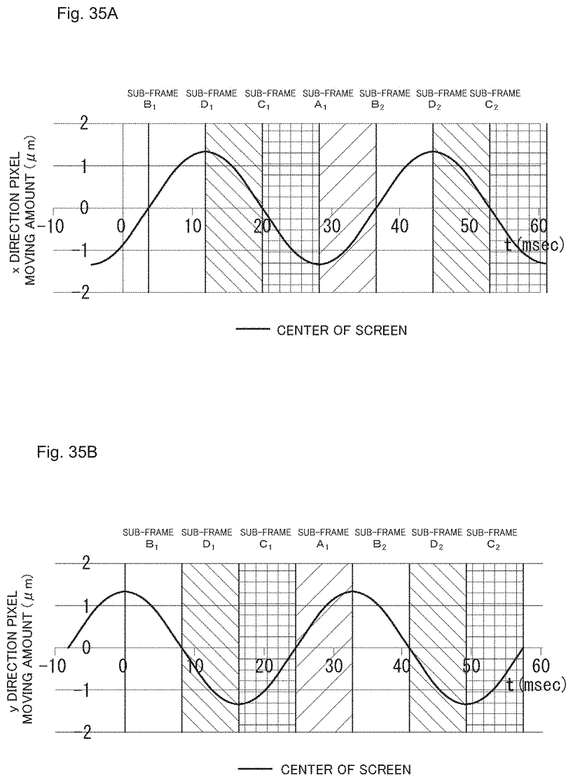

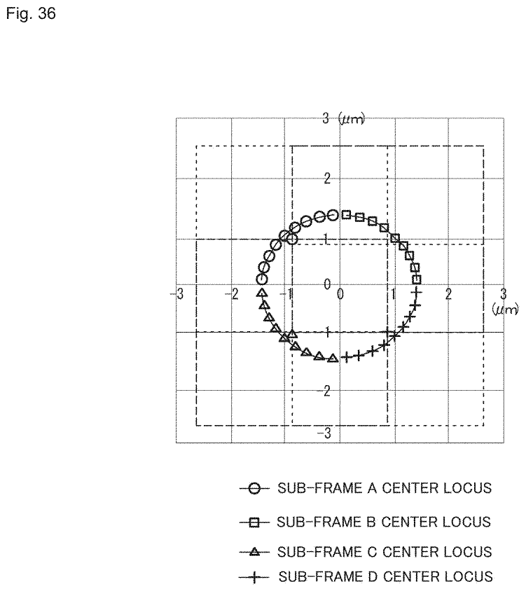

FIG. 35A and FIG. 35B indicate the relationship of the optical path shift change and frame switching at the center of the screen. FIG. 35A indicates the x direction pixel moving amount (μm), and FIG. 35B indicates the y direction pixel moving amount (μm). FIG. 36 indicates a locus of the pixel center when the sub-frames A/B/D/C are displayed at the center of the screen.

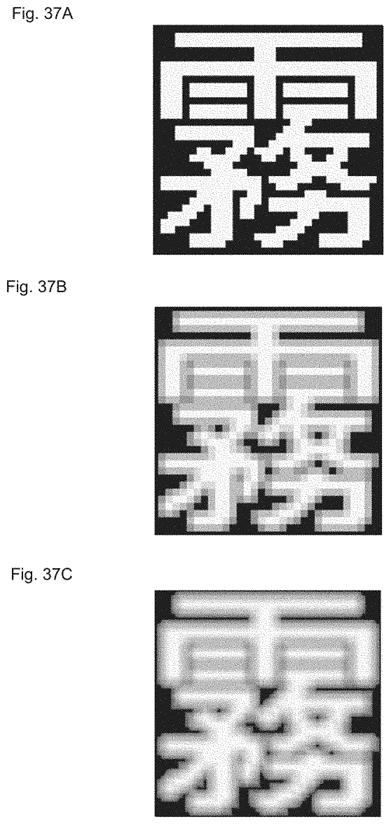

FIG. 37A indicates an image based on an original image pixel (8K), FIG. 37B indicates an image (ideal state) in a case where a four-level shift was completely performed in the display element (liquid crystal panel 17) at low resolution (4K), and FIG. 37C indicates an image at the center of the screen in a case where the shift was performed on the display element at low resolution (4K) by the optical path shift device according to Example 5.

In the optical path shift by the optical path shift device 24 according to the fifth embodiment, the timings of the shift with respect to frame switching match at the center of the screen, and each frame is displayed in a position close to the original display position, therefore, resolution of the displayed image can be improved, as indicated in FIG. 37C.

(2) In the Case of Upper Portion of the Screen

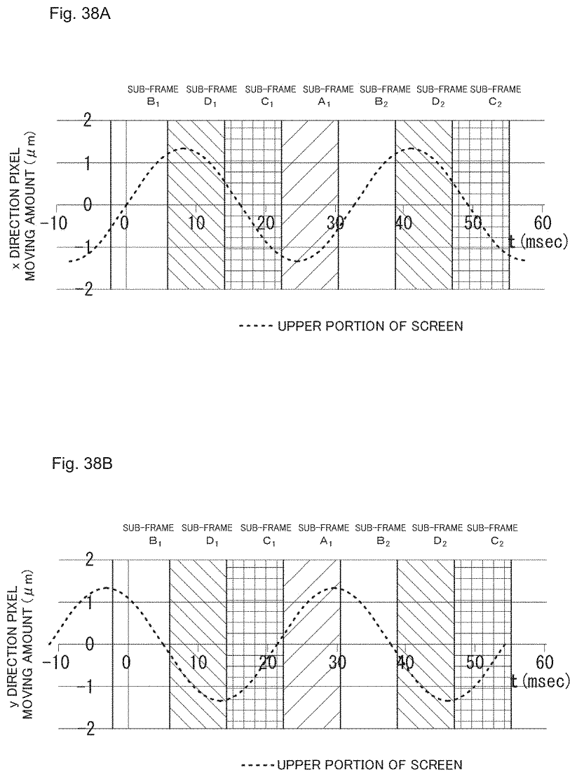

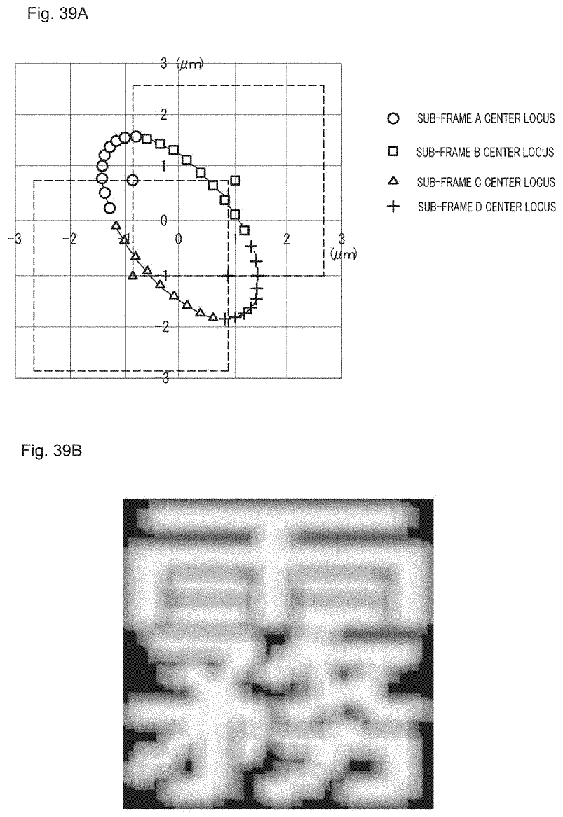

FIG. 38A and FIG. 38B indicate a relationship of the optical path shift change and frame switching in the upper portion of the screen. FIG. 38A indicates the x direction pixel moving amount (μm), and FIG. 38B indicates the y direction pixel moving amount (μm). FIG. 39A indicates a locus of the pixel center when the sub-frames A/B/D/C are displayed in the upper portion of the screen, and FIG. 39B indicates an image of the upper portion of the screen in the case where the optical path was shifted on the display element at low resolution (4K) by the optical path shift device 24 according to the fifth embodiment.

In the optical path shift by the optical path shift device 24 according to the fifth embodiment, deviation of the timing of the optical shift on the screen with respect to frame switching is improved in the upper portion of the screen, and the degree of the deviation of each frame from the original position further decreases, therefore the resolution of the displayed image can be improved, as indicated in FIG. 39B.

(3) In the Case of Lower Portion of the Screen

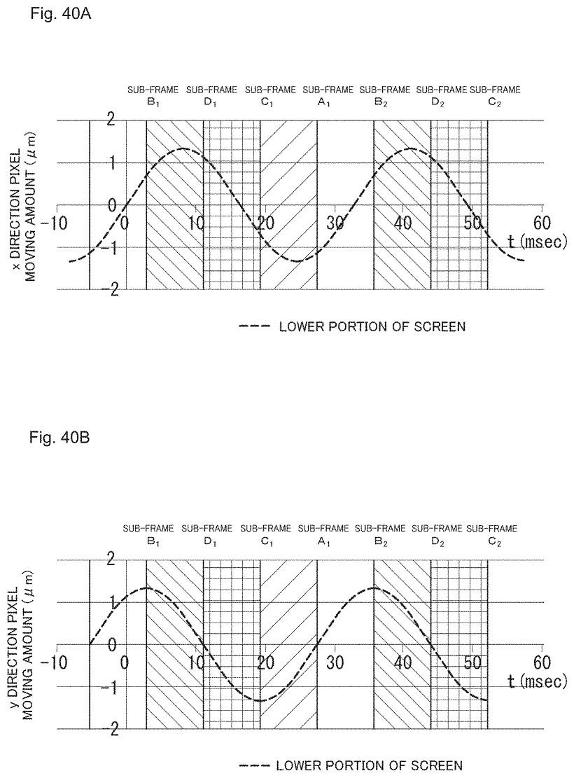

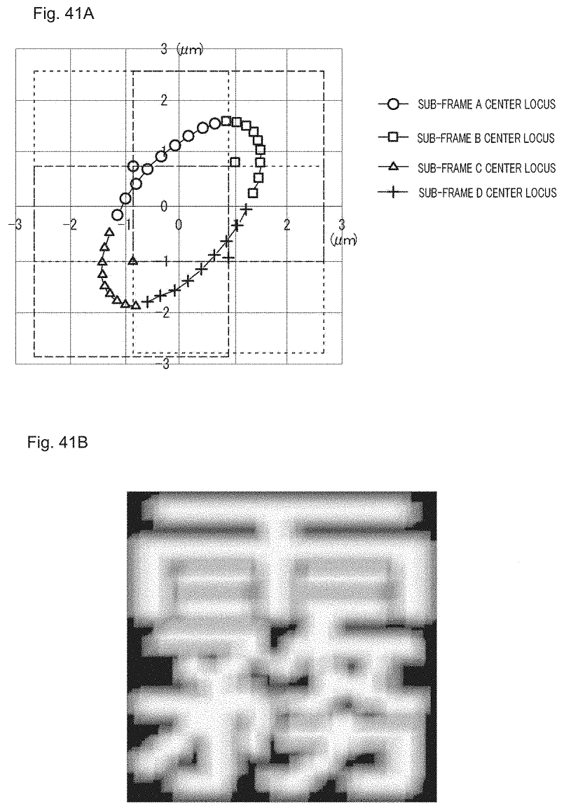

FIG. 40A and FIG. 40B indicate a relationship of the optical path shift change and frame switching in the lower portion of the screen. FIG. 40A indicates the x direction pixel moving amount (μm), and FIG. 40B indicates the y direction pixel moving amount (μm). FIG. 41A indicates a locus of the pixel center when the sub-frames A/B/D/C are displayed in the lower portion of the screen, and FIG. 41B indicates an image of the lower portion of the screen in the case where the optical path was shifted on the display element at low resolution (4K) by the optical path shift device 24 according to the fifth embodiment.

In the optical path shift by the optical path shift device 24 according to the fifth embodiment, deviation of the timing of the optical path shift with respect to frame switching is improved in the lower portion of the screen as well, just like in the case of the upper portion of the screen, and the degree of deviation of each frame from the original display position further decreases, therefore the resolution of the displayed image can be improved, as indicated in FIG. 41B.

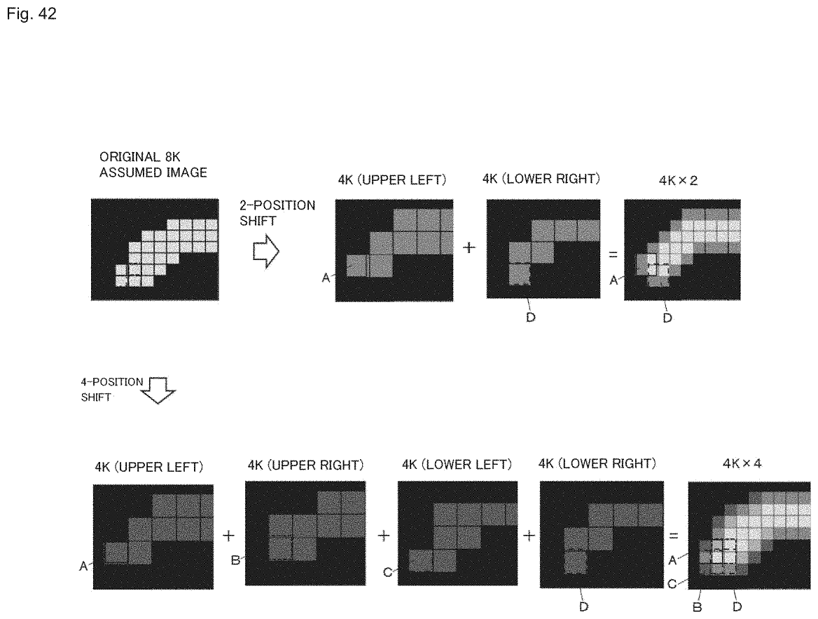

FIG. 42 indicates an original 8K assumed image, indicating images in a case where frame switching is a two-position shift of ADADAD . . . (first embodiment to fourth embodiment), and images in a case where frame switching is a four-position shift of ABDCABDC . . . (fifth embodiment).

In FIG. 42, the image at the extreme left on the upper level is the original 8K image. Then, on the upper level in FIG. 42, a 4K (upper left) image and a 4K (lower right) image and a combined image thereof, in the case of the two-position shift, are indicated in order from the left. On the lower level in FIG. 42, an image of 4K (upper left), an image of 4K (upper right), and image of 4K (lower left), an image of 4K (lower right) and a combined image thereof, in the case of the four-position shift, are indicated in order from the left.

### Modifications

While a preferred embodiment of the technique of the present disclosure has been described, the technique of the present disclosure is not limited to this embodiment. The configuration and structure of the display device described in this embodiment are examples, and may be changed as required. For example, in this embodiment, a case of applying the technique of the present disclosure to a transmission type liquid crystal panel was described as an example, but application of the technique of the present disclosure is not limited to the transmissions type liquid crystal panel, but may be a reflection type liquid crystal panel, a DLP® liquid crystal panel, and the like.

In any of the cases of the transmission type liquid crystal panel, the reflection type liquid crystal panel and the DLP® liquid crystal panel, a two-position shift or a four-position shift can be performed for the pixel shift (frame switching). Further, in both cases of two-position shift and four-position shift, the frequency of the pixel shift can be frame frequency×1 or frame frequency×½. Concerning the oscillation axes (tilt axes), the techniques of the first embodiment to the fifth embodiment may be appropriately combined for a combination of two X axes of the wedge plate-shaped members and the Y axis of the frame 33, a combination of two X axes of the wedge plate-shaped members and the Y axis of the parallel plate, and a combination of two 45° axes of the wedge plate-shaped members.

<Application Examples of Technique of the Present Disclosure>

In the above mentioned embodiment, the projection type display device was described as an example of the image display device to which the technique of the present disclosure is applied, but application of the technique of the present disclosure is not limited to the projection type display device, but may be various electronic apparatuses other than the projection type display device. Examples of applying the technique of the present disclosure to other electronic apparatuses will be described below.

### Application Example 1

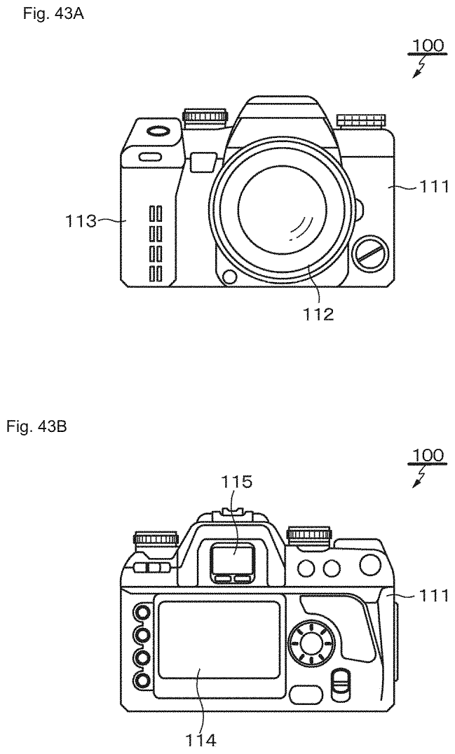

Application Example 1 is an example of applying the technique of the present disclosure to a lens interchangeable mirrorless single lens type digital still camera. FIG. 43A is a front view of the lens interchangeable mirrorless single lens type digital still camera according to Application Example 1, and FIG. 43B is a rear view of this digital still camera.

The lens interchangeable mirrorless single lens type digital still camera 100 includes an interchangeable image capturing lens unit (interchangeable lens) 112 on the right side of the front face of the camera main unit (camera body) 111, and has a grip unit 113 on the left side of the front face for the user to grip. Further, a monitor 114 is disposed approximately at the center of the rear face of the camera main unit 111. A view finder (eye piece window) 115 is disposed above the monitor 114. By peeping through the view finder 115, the user can visually check the optical image of a subject guided by the image capturing lens unit 112, and determine composition.

In the lens interchangeable single lens reflex type digital still camera 100 having the above configuration, the image display device of the present disclosure can be used as the view finder 115, which is disposed between the eye piece and the display element. In other words, the lens interchangeable single lens reflex type digital still camera 100 according to this application example is fabricated using the image display device of the present disclosure as the view finder 115 thereof.

### Application Example 2

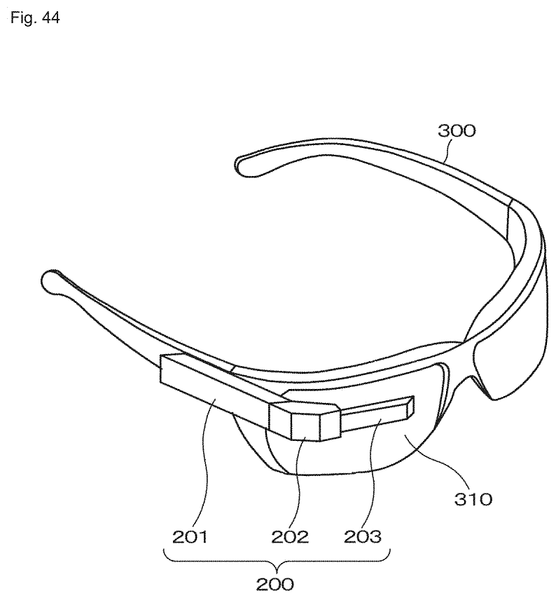

Application Example 2 is an example of applying the technique of the present disclosure to a head mounted display. FIG. 44 is an external view of the head mounted display (eyewear type display) according to Application Example 2.

The head mounted display 200 according to Application Example 2 has a transmission type head mounted display structure including a main unit 201, an arm unit 202 and a lens barrel 203. The main unit 201 is connected with the arm unit 202 and spectacles 300. Specifically, an edge of the main unit 201 in the longer direction is mounted on the arm unit 202. One of the side faces of the main unit 201 is connected to the spectacles 300 via a connecting member (not illustrated). The main unit 201 may be directly mounted on a human head.

The main unit 201 includes a control board to control the operation of the head mounted display 200, and a display unit. The arm unit 202 connects the main unit 201 and the lens barrel 203 so that the lens barrel 203 is supported by the main unit 201. Specifically, the arm unit 202 connects the edge of the main unit 201 and the edge of the lens barrel 203, whereby the lens barrel 203 is secured to the main unit 201. Furthermore, the arm unit 202 includes a signal line to communicate data related to an image supplied from the main unit 201 to the lens barrel 203.

The lens barrel 203 projects an image light, which is provided from the main unit 201 via the arm unit 202, toward the eyes of the user wearing the head mounted display 200 through the lens 310 of the spectacles 300.

As described above, the image display device of the present disclosure can be used as the head mounted display (eyewear type display) 200, which is disposed between a virtual image display surface and the display element. In other words, the head mounted display 200 according to this application example is fabricated using the image display device of the present disclosure.

### Application Example 31

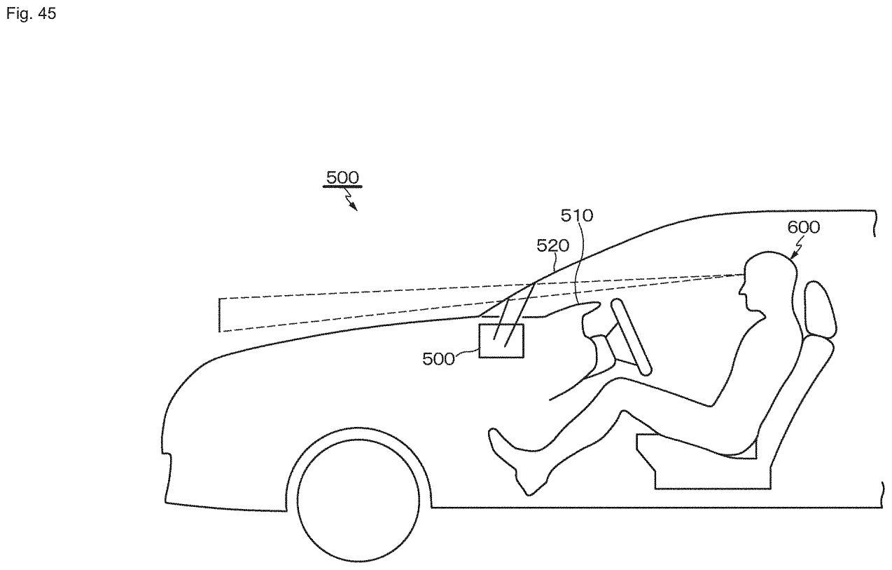

Application Example 3 is an example of applying the technique of the present disclosure to a head up display. FIG. 45 is a schematic diagram of a head up display according to Application Example 3.

The head up display 400 according to Application Example 3 is installed and used in a vehicle 500. The head up display 400 is disposed inside an instrument panel 510, and projects an image including various information to support driving, for example, from inside the instrument panel 510 onto a front windshield 520.

Thereby the driver 600 recognizes the projected image as if the image were displayed on a virtual display surface on the other side of the front windshield 520. As a result, the driver 600 can acquire various information to support driving from this image by viewing the image superimposed on the front windshield without moving their line of sight.

As described above, the image display device of the present disclosure can be used as the head up display 400, which is disposed between the virtual display surface and the display element. In other words, the head up display 400 according to this application example is fabricated using the image display device of the present disclosure.

<Possible Configuration of Present Disclosure>

The present disclosure may have the following configurations.

<A. Image Display Device>

[A-1]

An image display device including:

a first optical unit configured to change a traveling direction of an optical path by refracting light from a display element;
a second optical unit to which the light refracted by the first optical unit enters; and
a control unit configured to set a timing, to change the traveling direction of the optical path, to a state that is different among a plurality of regions, which are determined by dividing a display region of the display element in a scanning direction by controlling a distance between the first optical unit and the second optical unit so as to correspond to each of the plurality of regions.

[A-2]

The image display device according to the above [A-1], wherein

the first optical unit is constituted of at least one wedge plate-shaped member, of which cross-section parallel with the optical axis is wedge-shaped, and the second optical unit is constituted of a plate member.

[A-3]

The image display device according to the above [A-2], wherein

the control unit sets the timing to change the traveling direction of the optical path to a state that is different among the plurality of regions, by periodically changing inclination angles of the first optical unit and the second optical unit with respect to the optical axis.

[A-4]

The image display device according to the above [A-3], wherein

the control unit refracts the light from the display element using the first optical unit, so as to periodically change a distance from the first optical unit to the second optical unit among the plurality of regions.

[A-5]

The image display device according to the above [A-2], wherein

the second optical unit is constituted of a wedge plate-shaped member of which inclination is the same as the wedge plate-shaped member of the first optical unit.

[A-6]

The image display device according to the above [A-5], wherein

a total thickness of the first optical unit and the second optical unit is the same in a region corresponding to the optical path from the display element.

[A-7]

The image display device according to the above [A-6], wherein

the second optical unit returns the traveling direction of a beam, of which traveling direction of the optical path was changed by the first optical unit, back to the original traveling direction of the beam.

[A-8]

The image display device according to any one of the above [A-3] to [A-7], wherein in the periodic change of the inclination angles of the first optical unit and the second optical unit with respect to the optical path, the frequencies of the periodic change are the same, and phases of the periodic change are different.

[A-9]

The image display device according to the above [A-8], wherein

the first optical unit and the second optical unit are housed in a frame including a tilt axis along the X axis, so that the inclination angles are changeable around the X axis which is along the normal line of a cross-section of the wedge of the wedge plate-shaped member, and
the inclination angle of the frame is changeable around the Y axis which is along the normal line of a cross-section of the wedge plate-shaped member having a uniform thickness.

[A-10]

The image display device according to the above [A-9], wherein in the periodic change of the inclination angles of the first optical unit and the second optical unit with respect to the optical axis,

frequencies of the periodic change of the inclination angles are the same and phases of the periodic change of the inclination angles are different on the X axis, and
frequencies of the periodic change and phases of the periodic change of the inclination angles are the same on the Y axis.

[A-11]

The image display device according to the above [A-8], further including a third optical unit to which the light passed through the second optical unit enters, wherein

the third optical unit is constituted of a plate member that is inclinable around the Y axis which is along a normal line of a cross-section of the wedge plate-shaped member having a uniform thickness, and
the frequency of the periodic change of the inclination angle of the third optical unit on the Y axis is the same as the periodic change of the inclination angles of the first optical unit and the second optical unit.

[A-12]

The image display device according to the above [A-8], wherein

the inclination angles of the first optical unit and the second optical unit are changeable around an axis which is 45° inclined from the display element.

[A-13]

The image display device according to any one of the above [A-1] to [A-12], wherein

a driving method of the display element is a line-sequential driving method.

[A-14]

The image display device according to the above [A-13], wherein

a direction of changing the timing, to change the traveling direction of the optical path, among the plurality of regions is the same as the scanning direction of the line-sequential driving method.

[A-15]

The image display device according to the above [A-13] or [A-14], wherein

the direction of the Y axis which is along the normal line of the cross-section of the wedge plate-shaped member having a uniform thickness is the same as the scanning direction of the line-sequential driving method.

[A-16]

The image display device according to any one of the above [A-8] to [A-15], wherein

the frequencies of the periodic change of the inclination angles of the first optical unit and the second optical unit with respect to the optical axis are frequencies that are not higher than a pixel rewriting frequency in the display element.

<B. Electronic Apparatus>

[B-1]

An electronic apparatus equipped with an image display device, the image display device includes:

a first optical unit configured to change a traveling direction of an optical path by refracting light from a display element;
a second optical unit to which the light refracted by the first optical unit enters; and
a control unit configured to set a timing, to change the traveling direction of the optical path, to a state that is different among a plurality of regions, which are determined by dividing a display region of the display element in a scanning direction, by controlling a distance between the first optical unit and the second optical unit so as to correspond to each of the plurality of regions.

[B-2]

The electronic apparatus according to the above [B-1], wherein

the first optical unit is constituted of at least one wedge plate-shaped member, of which cross-section parallel with the optical axis is wedge-shaped, and
the second optical unit is constituted of a plate member.

[B-3]

The electronic apparatus according to the above [B-2], wherein

the control unit sets the timing to change the traveling direction of the optical path to a state that is different among the plurality of regions, by periodically changing inclination angles of the first optical unit and the second optical unit with respect to the optical axis.

[B-4]

The electronic apparatus according to the above [B-3], wherein

the control unit refracts the light from the display element using the first optical unit, so as to periodically change the distance from the first optical unit to the second optical unit among the plurality of regions.

[B-5]

The electronic apparatus according to the above [B-2], wherein

the second optical unit is constituted of a wedge plate-shaped member of which inclination is the same as the wedge plate-shaped member of the first optical unit.

[B-6]

The electronic apparatus according to the above [B-5], wherein

total thickness of the first optical unit and the second optical unit is the same in a region corresponding to the optical path from the display element.

[B-7]

The electronic apparatus according to the above [B-6], wherein

the second optical unit returns the traveling direction of a beam, of which traveling direction of the optical path was changed by the first optical unit, back to the original traveling direction of the beam.

[B-8]

The electronic apparatus according to any one of the above [B-3] to [B-7], wherein

in the periodic change of the inclination angles of the first optical unit and the second optical unit with respect to the optical path,
the frequencies of the periodic change are the same, and phases of the periodic change are different.

[B-9]

The electronic apparatus according to the above [B-8], wherein

the first optical unit and the second optical unit are housed in a frame including a tilt axis along the X axis, so that the inclination angles are changeable around the X axis which is along the normal line of a cross-section of the wedge of the wedge plate-shaped member, and
the inclination angle of the frame is changeable around the Y axis, which is along the normal line of a cross-section of the wedge plate-shaped member having a uniform thickness.

[B-10]

The electronic apparatus according to the above [B-9], wherein

in the periodic change of the inclination angles of the first optical unit and the second optical unit with respect to the optical axis,
frequencies of the periodic change of the tilt angles are the same and phases of the periodic change of the inclination angles are different on the X axis, and frequencies of the periodic change and phases of the periodic change of the inclination angles are the same on the Y axis.

[B-11]

The electronic apparatus according to the above [B-8], further including

a third optical unit to which the light passed through the second optical unit enters, wherein
the third optical unit is constituted of a plate member that is inclinable around the Y axis, which is along a normal line of a cross-section of the wedge plate-shaped member having a uniform thickness, and
the frequency of the periodic change of the inclination angle of the third optical unit on the Y axis is the same as the periodic change of the inclination angles of the first optical unit and the second optical unit.

[B-12]

The electronic apparatus according to the above [B-8], wherein

the inclination angles of the first optical unit and the second optical unit are changeable around an axis which is 45° inclined from the display element.

[B-13]

The electronic apparatus according to any one of the above [B-1] to [B-12], wherein

a driving method of the display element is a line-sequential driving method.

[B-14]

The electronic apparatus according to the above [B-13], wherein

a direction of changing the timing to change the traveling direction of the optical path among a plurality of regions is the same as the scanning direction of the line-sequential driving method.

[B-15]

The electronic apparatus according to the above [B-13] or [B-14], wherein

the direction of the Y axis, which is along the normal line of the cross-section of the wedge plate-shaped member having a uniform thickness, is the same as the scanning direction of the line-sequential driving method.

[B-16]

The electronic apparatus according to any one of the above [B-8] to [B-15], wherein

the frequencies of the periodic change of the inclination angles of the first optical unit and the second optical unit with respect to the optical axis are frequencies that are not higher than a pixel rewriting frequency in the display element.

### REFERENCE SIGNS LIST

1 Three-LCD projection type display device (an example of image display device of the present disclosure)
11 Light source
12 Polarization conversion element
13 Fly-eye lens
14, 18 Dichroic mirror
15, 20, 22 Mirror
17 (17R, 17G, 17B) Liquid crystal panel
23 Cross prism
24 Optical path shift device
25 Projection lens
26 Control unit
31 First optical unit
32 Second optical unit
33 Frame
34, 35 Tilt axis of X axis
36, 36a, 36b Tilt axis of Y axis
37 Third optical unit
37 Parallel plate
38a, 38b, 39a, 39b Tilt axis inclined by 45°

1. An image display device comprising:
a first optical unit configured to change a traveling direction of an optical path by refracting light from a display element;
a second optical unit to which the light refracted by the first optical unit enters; and
a control unit configured to set a timing, to change the traveling direction of the optical path to a state that is different among a plurality of regions, which are determined by dividing a display region of the display element in a scanning direction, by controlling a distance between the first optical unit and the second optical unit so as to correspond to each of the plurality of regions.

2. The image display device according to claim 1, wherein
the first optical unit is constituted of at least one wedge plate-shaped member, of which cross-section parallel with the optical axis is wedge-shaped, and
the second optical unit is constituted of a plate member.

3. The image display device according to claim 2, wherein
the control unit sets the timing to change the traveling direction of the optical path to a state that is different among the plurality of regions, by periodically changing inclination angles of the first optical unit and the second optical unit with respect to the optical axis.

4. The image display device according to claim 3, wherein
the control unit refracts the light from the display element using the first optical unit, so as to periodically change a distance from the first optical unit to the second optical unit for every plurality of regions.

5. The image display device according to claim 2, wherein
the second optical unit is constituted of a wedge plate-shaped member of which inclination is the same as the wedge plate-shaped member of the first optical unit.

6. The image display device according to claim 5, wherein
a total thickness of the first optical unit and the second optical unit is the same in a region corresponding to the optical path from the display element.

7. The image display device according to claim 6, wherein
the second optical unit returns the traveling direction of a beam, of which traveling direction of the optical path was changed by the first optical unit, back to the original traveling direction of the beam.

8. The image display device according to claim 3, wherein
in the periodic change of the inclination angles of the first optical unit and the second optical unit with respect to the optical path,
the frequencies of the periodic change are the same, and phases of the periodic change are different.

9. The image display device according to claim 8, wherein
the first optical unit and the second optical unit are housed in a frame including a tilt axis along the X axis, so that the inclination angles are changeable around the X axis which is along the normal line of a cross-section of the wedge of the wedge plate-shaped member, and
the inclination angle of the frame is changeable around the Y axis which is along the normal line of a cross-section of the wedge plate-shaped member having a uniform thickness.

10. The image display device according to claim 9, wherein
in the periodic change of the inclination angles of the first optical unit and the second optical unit with respect to the optical axis,
frequencies of the periodic change of the inclination angles are the same and phases of the periodic change of the inclination angles are different on the X axis, and
frequencies of the periodic change and phases of the periodic change of the inclination angles are the same on the Y axis.

11. The image display device according to claim 8, further comprising
a third optical unit to which the light passed through the second optical unit enters, wherein
the third optical unit is constituted of a plate member that is inclinable around the Y axis which is along a normal line of a cross-section of the wedge plate-shaped member having a uniform thickness, and
the frequency of the periodic change of the inclination angle of the third optical unit around the Y axis is the same as the periodic change of the inclination angles of the first optical unit and the second optical unit.

12. The image display device according to claim 8, wherein
the inclination angles of the first optical unit and the second optical unit are changeable around an axis which is 45° tilted inclined from to the display element.

13. The image display device according to claim 1, wherein
a driving method of the display element is a line-sequential driving method.

14. The image display device according to claim 13, wherein
a direction of changing the timing, to change the traveling direction of the optical path, among a plurality of regions is the same as the scanning direction of the line-sequential driving method.

15. The image display device according to claim 13, wherein
the direction of the Y axis which is along the normal line of the cross-section of the wedge plate-shaped member having a uniform thickness is the same as the scanning direction of the line-sequential driving method.

16. The image display device according to claim 8, wherein
the frequencies of the periodic change of the inclination angles of the first optical unit and the second optical unit with respect to the optical axis are frequencies that are not higher than a pixel rewriting frequency in the display element.

17. An electronic apparatus equipped with an image display device, wherein
the image display device comprises:
a first optical unit configured to change a traveling direction of an optical path by refracting light from a display element;
a second optical unit to which the light refracted by the first optical unit enters; and
a control unit configured to set a timing to change the traveling direction of the optical path to a state that is different among a plurality of regions, which are determined by dividing a display region of the display element in a scanning direction, by controlling a distance between the first optical unit and the second optical unit so as to correspond to each of the plurality of regions.
